(19) United States
(12) Patent Application Publication
(10) Pub. No.: US 2026/0067520 A1
(43) Pub. Date: Mar. 5, 2026

(54) AUTOMATIC MODERATION FOR CONTENT SHARING

(71) Applicant: Roblox Corporation, San Mateo, CA (US)

(72) Inventors: Garima SINHA, San Mateo, CA (US); Irene NGUYEN, San Mateo, CA (US); Darragh Michael GRIFFIN, San Mateo, CA (US)

(73) Assignee: Roblox Corporation, San Mateo, CA (US)

(21) Appl. No.: 19/318,894

(22) Filed: Sep. 4, 2025

Related U.S. Application Data
(60) Provisional application No. 63/691,307, filed on Sep. 5, 2024.

(51) Int. Cl. H04N 21/2743; H04N 21/234; H04N 21/239; H04N 21/266; H04N 21/431; H04N 21/472

(52) U.S. Cl. CPC H04N 21/2743; H04N 21/23418; H04N 21/2393; H04N 21/266; H04N 21/4312; H04N 21/472

(57) ABSTRACT

Methods, computer-readable media, and systems manage content at a server, including receiving a request from a user to post shared content to the server; validating that an origin of the shared content is a valid origin; and in response to validating that the origin of the shared content is the valid origin: storing the shared content at the server as draft content; analyzing the draft content by running a server-side artificial intelligence (AI) model to obtain a content moderation result; in response to the content moderation result indicating that the draft content is safe, decorating and storing the content at the server in a published state, wherein decorating the content comprises customizing and enhancing a visual appearance of the content; and in response to the content moderation result indicating that the draft content is unsafe, storing the content at the server in a rejected state.

### CROSS-REFERENCE TO RELATED APPLICATIONS

This application claims priority under 35 U.S.C. § 119(e) to U.S. Provisional Patent Application No. 63/691,307 , entitled “AUTOMATIC MODERATION FOR CONTENT SHARING,” filed on Sep. 5, 2024, the content of which is incorporated herein in its entirety.

### TECHNICAL FIELD

This disclosure relates generally to computer graphics, and more particularly but not exclusively, relates to methods, systems, and computer readable media that provide an infrastructure to enable content sharing with automatic content moderation. Content moderation facilitates safe sharing of video and/or image content by a user to a corresponding user profile and enables other users to view content on that profile.

### BACKGROUND

In three-dimensional (3D) modeling and game development (or for other contexts of virtual experiences), it may be useful to make video and/or image content sharing possible. There may already be a content sharing platform available, either using ephemeral content or permanently stored content. There may also be a plurality of elements provided by the content sharing platform used to retrieve and manage video content correctly, as well as to keep the costs of managing such video content manageable. However, current techniques used for content sharing have a number of drawbacks.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the prior disclosure.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by a data processing apparatus, cause the apparatus to perform or control performance of the actions.

According to one aspect, a computer-implemented method to manage content at a server in a virtual environment is provided, the method comprising: receiving a sharing request from a user via a client device to post shared content to the server; validating that an origin of the shared content is a valid origin; and in response to validating that the origin of the shared content is the valid origin: storing the shared content at the server as draft content; analyzing the draft content by running a trained server-side artificial intelligence (AI) model to obtain a content moderation result, wherein the content moderation result indicates whether the draft content is safe or unsafe; in response to the content moderation result indicating that the draft content is safe, decorating and storing the content at the server in a published state, wherein decorating the content comprises customizing and enhancing a visual appearance of the content based on input from the user; and in response to the content moderation result indicating that the draft content is unsafe, storing the content at the server in a rejected state.

Various implementations of the computer-implemented method are described herein.

In some implementations, the shared content comprises video content, one or more screenshots, audio content, or a combination thereof.

In some implementations, the shared content comprises the one or more screenshots, and the method further comprises: generating respective thumbnails for the one or more screenshots; storing the thumbnails; and compressing the one or more screenshots prior to storing the one or more screenshots.

In some implementations, the shared content comprises the video content, and wherein the video content is converted into the one or more screenshots by sampling stills from the video content.

In some implementations, the shared content comprises the video content, and the method further comprises compressing the video content by downsampling the video content to a lower resolution, lowering a frame rate associated with the video content, or a combination thereof, and generating thumbnails associated with the video content for display in a user interface, wherein selection of a thumbnail from the user interface enables access to the video content.

In some implementations, analyzing the draft content is performed using synchronous analyzing when the draft content is one or more screenshots and is performed using asynchronous analyzing otherwise.

In some implementations, asynchronous analyzing comprises providing a token to the client device for use in accessing the draft content, in response to storing the draft content and notifying the user when the analyzing is complete.

In some implementations, the method further comprises in response to the content moderation result indicating that the draft content is unsafe, performing an appeals process for the draft content, wherein the appeals process is triggered in response to a user request, and the appeals process comprises obtaining a new content moderation result based on different parameters and blocking the draft content again if the new content moderation result is another unsafe result.

In some implementations, the content moderation result comprises a safety score associated with the draft content, and the method further comprises tagging for human moderation of the draft content that has a safety score lower than a threshold value.

In some implementations, the method further comprises in response to validating that the origin of the shared content is the valid origin, displaying the shared content as part of a user profile of an originating user that provided the shared content, wherein the user profile is based on an age of the originating user, a location of the originating user, or a combination thereof.

In some implementations, validating that the origin of the shared content is the valid origin comprises: applying a hashing technique to the shared content to obtain a first hash value; making a server call based on the first hash value using protected code; signing a capture hash based on a result of the server call to generate a signature; returning the signature using a server-side secret key; and using the signature as part of the validating, wherein the signature is stored on the client device and the validating comprises passing the signature back to the server on a sharing event, wherein the server hashes the shared content and rebuilds the signature with an experience ID and the server-side secret key to match the passed signature and the rebuilt signature.

According to another aspect, a non-transitory computer-readable medium is provided. The non-transitory computer-readable medium has instructions stored thereon that, responsive to execution by a processing device, cause the processing device to perform or control performance of operations to manage content at a server in a virtual environment, the operations comprising: receiving a sharing request from a user via a client device to post shared content to the server; validating that an origin of the shared content is a valid origin; and in response to validating that the origin of the shared content is the valid origin: storing the shared content at the server as draft content; analyzing the draft content by running a trained server-side artificial intelligence (AI) model to obtain a content moderation result, wherein the content moderation result indicates whether the draft content is safe or unsafe; in response to the content moderation result indicating that the draft content is safe, decorating and storing the content at the server in a published state, wherein decorating the content comprises customizing and enhancing a visual appearance of the content based on input from the user; and in response to the content moderation result indicating that the draft content is unsafe, storing the content at the server in a rejected state.

Various implementations of the non-transitory computer-readable medium are described herein.

In some implementations, analyzing the draft content is performed using synchronous analyzing when the draft content is one or more screenshots and is performed using asynchronous analyzing otherwise.

In some implementations, asynchronous analyzing comprises providing a token to the client device for use in accessing the draft content, in response to storing the draft content and notifying the user when the analyzing is complete.

In some implementations, the content moderation result comprises a safety score associated with the draft content, and the operations further comprise tagging for human moderation of the draft content that has a safety score lower than a threshold value.

In some implementations, the operations further comprise in response to validating that the origin of the shared content is the valid origin, displaying the shared content as part of a user profile of an originating user that provided the shared content, wherein the user profile is based on an age of the originating user, a location of the originating user, or a combination thereof.

According to another aspect, a system is provided, the system comprising: a memory with instructions stored thereon; and a processing device, coupled to the memory, the processing device configured to access the memory and execute the instructions, wherein the instructions cause the processing device to perform or control performance of operations to manage content at a server in a virtual environment, the operations comprising: receiving a sharing request from a user via a client device to post shared content to the server; validating that an origin of the shared content is a valid origin; and in response to validating that the origin of the shared content is the valid origin: storing the shared content at the server as draft content; analyzing the draft content by running a trained server-side artificial intelligence (AI) model to obtain a content moderation result, wherein the content moderation result indicates whether the draft content is safe or unsafe; in response to the content moderation result indicating that the draft content is safe, decorating and storing the content at the server in a published state, wherein decorating the content comprises customizing and enhancing a visual appearance of the content based on input from the user; and in response to the content moderation result indicating that the draft content is unsafe, storing the content at the server in a rejected state.

Various implementations of the system are described herein.

In some implementations, analyzing the draft content is performed using synchronous analyzing when the draft content is one or more screenshots and is performed using asynchronous analyzing otherwise.

In some implementations the content moderation result comprises a safety score associated with the draft content, and the operations further comprise tagging for human moderation of the draft content that has a safety score lower than a threshold value.

In some implementations, the operations further comprise in response to validating that the origin of the shared content is the valid origin, displaying the shared content as part of a user profile of an originating user that provided the shared content, wherein the user profile is based on an age of the originating user, a location of the originating user, or a combination thereof.

According to yet another aspect, portions, features, and implementation details of the systems, methods, and non-transitory computer-readable media may be combined to form additional aspects, including some aspects which omit and/or modify some or portions of individual components or features, include additional components or features, and/or other modifications, and all such modifications are within the scope of this disclosure.

### BRIEF DESCRIPTION OF THE DRAWINGS

FIG. 1 is a diagram of an example system architecture that facilitates content sharing, in accordance with some implementations.

FIG. 2 is a diagram illustrating a workflow for capturing and sharing content, in accordance with some implementations.

FIG. 3 is another diagram illustrating another workflow for capturing and sharing content, in accordance with some implementations.

FIG. 4 is a diagram illustrating a workflow for viewing content, in accordance with some implementations.

FIG. 5 is a diagram illustrating a workflow for user content deletion, in accordance with some implementations.

FIG. 6 is a diagram illustrating a workflow for validating that content comes from a designated source, in accordance with some implementations.

FIG. 7 is a flowchart illustrating a method to share content, in accordance with some implementations.

FIG. 8 is a flowchart illustrating a method to manage screenshots, in accordance with some implementations.

FIG. 9 is a flowchart illustrating a method to manage video content, in accordance with some implementations.

FIG. 10 is a flowchart illustrating a method to perform various types of analyzing, in accordance with some implementations.

FIG. 11 is a flowchart illustrating a method to validate content, in accordance with some implementations.

FIG. 12 is a block diagram that illustrates an example computing device which may be used to implement one or more features described herein, in accordance with some implementations.

### DETAILED DESCRIPTION

In the following detailed description, reference is made to the accompanying drawings, which form a part hereof. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “one implementation,” “an implementation,” “an example implementation,” etc. indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, such feature, structure, or characteristic may be affected in connection with other implementations whether or not explicitly described.

The present disclosure is directed towards, inter alia, safe content sharing in an online platform by the use of content moderation techniques. The present disclosure provides techniques for content capture, content sharing, artificial intelligence (AI)-based content moderation, content counting/tracking, content viewing, content deletion, content editing, user content reporting, content filtering, content validation, and content storage.

Managing content as described herein may involve certain internal infrastructure to share content internally effectively. Images (and other content, such as video) also may be confirmed as being safe. This confirmation includes checking for material that violates protective policies, confirming that content is from an expected source, and verifying that the content conforms to the content safety guidelines of a content sharing platform such as a virtual environment.

Content safety guidelines may be obtained based on applicable local regulations as well as policies adopted by the content sharing platform. It is useful to ensure content sharing is conducted in accordance with the guidelines and to do the content sharing in a cost effective manner that scales with the size of the platform. Likewise, it is useful to store the content in a cost effective manner.

In some implementations, content management may include receiving a request from a user to post content to a server, validating an origin of the content, storing the content as draft content, and running a server-side artificial intelligence (AI) model to perform content moderation on the content. If the content successfully passes the content moderation check, the content may be stored in a published state. If the content fails the content moderation check, the content may be stored in a rejected state. The content may be decorated prior to the storing. A rejection of the content may be appealed.

The described content management techniques can be utilized for different types of content, including images (e.g., screenshots) and/or video. Content may also be permitted to be deleted and/or edited. In some implementations, the content may be screenshots and/or video captured from a virtual experience (e.g., a game) within a virtual environment. An avatar associated with the user participates in the virtual experience. The content may be captured as the participation occurs. In some implementations, context from the source/game/environment/etc. may be stored in association with the content when content is captured. Such context may aid in managing the content.

When delivering content for viewing, content rendering and views may be filtered based on the context of the viewer. As an example, users aged 13 and under may be provided with content (e.g., screenshots and/or video) from virtual experiences targeted to such an age group. Also, users are provided with options to report content that violates a policy or that the users want to flag (e.g., as unsafe, inappropriate, etc.). Content sharing is not exclusive to a user posting sharable content but may also enable groups (e.g., user groups that participate in a virtual experience together) and virtual experience creators (e.g., experience entities) to post/repost content and to do so safely.

### Problem

A problem addressed herein is that making safe content sharing for screenshots and/or video in a virtual environment possible involves additional infrastructure. For example, content may have an entry point that helps the content to be shared. Also, it may be helpful for inputs to be safe (for example, include filtering offensive material, confirming the origin of inputs, and that the content conforms to content safety guidelines for the product, platform policies, and any applicable regulations).

Such content safety is to processed in a cost effective way. It may also be useful to provide effective ways to manage and store screenshots and video, delete and edit content, and control the persistence of content. Content also is to be reportable and present techniques lack group-based capabilities to manage content in such a way.

### Solution

To facilitate content sharing and automatic content moderation, various implementations provide several useful technical features. The implementations may provide functionality based on content capture techniques. A user can create a sharing request and add content to the sharing request. The user then submits the request to a server as a request to post the content. That is, the request acts as a mechanism to post shared content. The server receives the request. After receipt, the server performs basic validation of the content. The validation may help ensure the integrity of the content.

In a virtual environment, users may be associated with virtual avatars that participate in a virtual experience. The avatars may engage in interaction such as gameplay in the virtual experience via a client application (e.g., desktop or mobile application, browser or browser plugin, etc.). For example, various virtual experiences may support activities such as games (e.g., car racing, basketball, etc.), puzzles, quizzes, social gatherings, meetings, parties, etc. where multiple avatars participate. Games and related game functionality are being used at times herein as examples, and the content moderation features described herein can be adapted to other types of virtual experiences that may not necessarily involve games.

A user associated with an avatar may capture a screenshot or video of the virtual experience during the user participation in the virtual experience. To avoid tampering with the virtual environment, such as cheating, the content may be authentic as recorded from the actual interaction such as gameplay and not be manipulated.

Malicious users may try to generate and post modified content that is not generated from an actual virtual experience (e.g., a modified recording) or fake content, such as a synthetically generated video of a virtual experience. To reduce the possibility that such modified or fake content is not shared, validation of the content is performed. In some implementations, the validation includes confirming that the content was generated from an authorized client application. The data is then stored as draft content.

The data (e.g., images or video of the content) can be run through an automatic content moderation tool (e.g., a content moderation tool implemented using a server-side AI model). For example, the automatic content moderation tool may include capabilities that permit the automatic content moderation tool to automatically identify offensive material (or other material that violates platform policies).

There may be a content moderation result provided in response to the request to the automatic content moderation tool, which may be a content moderation result indicating that the content is valid or a content moderation result indicating that the content is valid. The server posts the content in response to the content moderation result.

If the result indicates that the content is valid, the content is stored in a published state. If the result indicates that the content is invalid, the content is stored in a rejected state (though a rejection can be appealed in an appeals process). The content may also be decorated prior to being stored. Decorating may involve performing color and texture customization, adding details, utilizing decals and wall trims, or other operation(s) to change the appearance of the content, for example. Such decorating may permit the user to change the appearance of the content.

### Assumptions for Videos

It may be further helpful to run moderation in particular ways for various videos, as well as the audio associated with the video. Videos may be supported using the same request entities as screenshots, but with a different type (video instead of image). Automatic content moderation and sharing can be supported for video content of various resolutions and durations. For example, a resolution of 720p and a duration of up to 30 seconds may be a good balance of performance, cost, and quality. In other implementations, the resolution and durations may differ.

Content capture may be done at the recording process (e.g., while an avatar participates in a virtual experience), based on the frame rate and quality that are chosen (e.g., resolutions of 1080p, 720p, etc., frame rates of 30 frames per second, 60 frames per second, etc.). If it is not possible to perform the content capture at the recording stage, it may useful to convert the videos into the recommended format on the client side.

Also, thumbnails can be selected for the videos. In some implementations, the specific time for a video thumbnail may be selected by the user but auto-selection by the client is acceptable in other implementations. A thumbnail service can be used to thumbnail the still image, such as by downsampling the still image into a similar image with a smaller resolution.

For example, to begin, 30 random stills from the video may be selected to run through image moderation using an automatic moderation tool. If the tool catches any issue with any of the random stills, the whole video may be identified as failing moderation. In some implementations, the random sampling (to select the 30 random stills from the video) may be used to prevent bad actors from reverse engineering the distribution of the stills selected for moderation and using the identified distribution to hide bad/violative content in videos. If audio is present, audio AI moderation may also be done using voice moderation techniques to detect problematic content in the audio.

In some implementations, the number of random stills may vary between sampling only one random still and sampling every still in the video. The more stills that are run through the image moderation, the better the chance that no inappropriate content is missed, but processing more stills may increase the use of additional computing resources in the moderation process, and so the number of processed stills can be selected so as to more efficiently use computing resources.

In some implementations, content moderation may include an asynchronous posting mechanism, where the user submits the video (or image), gets a token back subsequently, and may be notified when the video has been processed and posted (or rejected). For reporting and appeals, in some implementations, as with moderating screenshots, the moderation processes may provide for videos being provided to human reviewers that are trained for video moderation in situations where the automatic moderation provides results having a confidence score less than a threshold.

### Compression & Downsampling+Thumbnails

In some implementations, the content is stored at a suitable (e.g., consistent) file size, in a suitable format. The format and file size may be chosen based on available computing resources, display settings, and user settings. Additionally, thumbnails may be created for videos, and users enabled to select thumbnails for the videos. Starting with the downsampling (as compared to a screen size), there are a few techniques to do the downsampling. In some implementations, a video capture system captures the video at the target resolution instead of screen resolution.

For example, the video capture is captured at 720p at 30 frames-per-second rather than being captured at 1080p at 30 frames-per-second (fps). This technique is potentially advantageous with respect to computational resources.

In other implementations, the client may be configured with the ability to subsequently convert a recorded video to a downsampled version. In such an implementation, a background process may be performed on the video to convert the video before sending the video to the server for sharing.

This technique is useful in some implementations, because the client is responsible for the cost associated with downsampling the video itself, reducing server workload. Such implementations may also permit full quality video to still be saved to the device. These implementations also take less computation resources for video capture but may involve management of time/computation resources for video sharing.

In other implementations, the server may perform downsampling of video to a smaller format (e.g., a format that stores the video with a reduced file size). Such implementations may have the benefit of applying additional compression at this time. In this implementation, it may take additional server computation to convert the videos. In some implementations, for thumbnails, it may be possible to integrate the implementations with a thumbnail service, by either providing the thumbnail service with a still that was pre-selected from the client, or by passing the video with a frame number and frame information to the thumbnail service.

### Checking/validating Video Source

One aspect of implementations is checking the identity of and/or validating a video source. This aspect follows a similar approach to the approach using content sharing for screenshots. The feature for video content capture is to take a few screenshots in a game environment or other type of virtual experience during the recording (at random, as discussed herein), and tagging a timestamp associated with the screenshot.

The client device may then send the video to the game environment (or other virtual experience environment) and the game environment may take stills from the video at the timestamps of the game environment screenshots. The game environment may then run these stills through the same image similarity model. If the stills are similar, the game environment may create a secure hash (using a server-side security key) to send back to the client. On share, the client may submit the video with the secure hash, which may be verified using the server-side security key.

### AI Moderation Considerations

When a video is acquired, a random frame from every second of the video may be chosen. A random frame is chosen to prevent problematic frames from being hidden into videos. These random frames (up to a certain count, assuming a certain maximum video length) may go through a screenshot moderation filter (e.g., an artificial intelligence (AI) based filter). The filter may be trained to identify problematic content.

Audio may also go through a voice moderation filter to detect toxicity or other issues. For reporting and appeals purposes, all of the frames may go through moderation, instead of a randomly selected subset of the frames. In some implementations, the worst screenshot (e.g., a screenshot with the most issues of concern or a worst safety score) may be taken as the point of analysis. Additionally, human moderation may be performed to integrate videos as well as screenshots, if the safety score is less than a threshold. Human moderators may be also trained to look for issues in videos as well as screenshots.

The worst (e.g., the most problematic/violative) screenshots may be highlighted for the human moderators. Such screenshots may be selected based on a safety score associated with the screenshots, indicating that these screenshots are considered to be the least safe. A human moderation cost for videos may be more expensive than a cost to perform automatic screenshot and/or video moderation. Human moderation may also create delays. Hence, any automatic moderation that obviates the involvement of all or some human moderation may result in a helpful cost savings and expedite the content moderation.

### Database/Storage Considerations for Videos

In some implementations, a posting service and a corresponding database (or another form of storage) may be utilized to also store and serve videos, such as by using cloud storage links and calls. From a storage perspective, videos may be stored in the same (or a similar) manner as screenshots.

For example, content may be stored by using a file system, a cloud storage, or an equivalent storage solution like a database (this choice of storage repository may be tied to the decision of where screenshots corresponding to the video storage are to be stored). For permanent storage of video, a storage strategy may be based on determining a cost-effective way to handle the large amounts of associated data before proceeding forward with utilizing the data. Various types of storage provide different capabilities at different costs and may be chosen accordingly.

### Serving and Render Considerations

An existing video content delivery network (CDN) may be used for streaming videos to the clients. If the CDN does not support streaming and lowering video quality, such features may be added as an improvement to the CDN. These features may provide capabilities that facilitate successful video sharing.

### Design

In content capture, a user captures content, the content is securely signed by a cloud service, and the content is stored locally by the client. The user shares the content (such as a screenshot or video). The server validates the content in a virtual environment and runs an automatic moderation tool. On a server validation success, the content is stored for viewing. The storing is dependent on the results of the automatic moderation tool.

Content capture may include a series of operations. In one operation, the user creates a sharing request, which shares captured content. In another operation, the user adds and edits screenshots, videos, or other content to the sharing request. The user submits the sharing request. The request to post content is sent to the server.

The server receives the sharing request. The server validates that the content comes from an official and/or legitimate source (for the content). The data in the content request is stored as a draft. A server-side AI model may be run for content moderation (the model may be integrated into an automatic moderation program). The content may be stored as published or rejected based on the results of the model. Then, a thumbnail and/or resized image is created from the content. Afterwards, the content is promoted accordingly by being shared in accordance with the results.

### AI Moderation Processing/Training/Appeal

The content infrastructure integrates automatic moderation. The automatic moderation may include an image moderation model. The image moderation model may be trained to evaluate images (e.g., screenshots) to detect violations of platform policy and provide a moderation result that indicates whether or not particular content to be shared violates policy. The automatic moderation may be extended to video as well.

For example, there may be synchronous processing or asynchronous processing of the content sharing request. In synchronous processing, there may be an entity/service to manage requests, such that the automatic moderation may include fetching text/images/video based on a given request.

In asynchronous processing, the content may be stored right away and moderated after initially storing the content. The final result may occur and be reported later, after moderation occurs.

Another alternative for moderation may be AI processing using the automatic moderation before storage. In some implementations, a client device may run a moderation model on the client itself and pass the model result to the server. The server can then use the model result as an input of the model during a server-side moderation model run, providing for a speed up of the server-side model.

Another alternative for some implementations may be AI processing at report only. This option is to not process all of the content but instead rely on user reports to selectively moderate certain content (e.g., that is reported by one or more users as possibly violative). In this case, automatic moderation is performed on content based on user reports.

There may be a possibly lower threshold to send the data over to moderators. Because users already reported the content, the threshold for an AI model indication of violation may be lowered. The AI model may be iteratively improved by updating the model based on functionality metrics from live runs (e.g., false positives and/or negatives from training content marked as violative or not violative based on human moderation) to update model parameters via training (e.g., supervised learning/training).

There may also be an appeal process provided. Requests which fail automatic moderation as well as manual moderation may be eligible for appeal. The appeal process may begin with a user (e.g., the user who initiates content sharing) triggering an appeal process. After an appeal is triggered, automatic moderation may be re-run with different thresholds followed by manual moderations based on whether the new automatic moderation changes a moderation result. The manual moderation may lead to a new, finalized moderation result.

### View Counting and Tracking

Some implementations may be designed to count the number of times certain content was viewed. In addition to simply tracking the number of views, it may also be possible, with appropriate user permissions, to identify specific users and track which users view content and when the views occur.

### Content Viewing

In some implementations, upon successful validation, shared content may be displayed as part of a user profile of a user that shared the content. The flow for content viewing may be as follows. A viewing user may view the profile of a target user (the target user can be the same user). The feature may be integrated into a profile platform to serve the requests. A sharing and requests service may be called to find the content shared by the user (which may be paginated), such as by time. The service may also obtain various criteria associated with the user.

In particular, with appropriate user permissions, the sharing and requests service may determine (e.g., via a database or cloud storage lookup) the age and/or location of the user and comparing that information with what content the user can view. In some implementations, this retrieval only fetches data from the last twenty-four hours. In other implementations, if permission management for requests is also included, the permissions may specify a role of the user (such as if the user is a friend, follower, etc.).

A user shared content table in a database (or another form of storage) may help to find content suitable for the viewing user, against the target user. Some implementations may return the IDs of the requests which are to be decorated by the frontend, which is the part of the system the user interacts with. The frontend may batch retrieve the content associated with the requests on render of the tile. The frontend may then fetch the images from cloud storage once the frontend gets back the content from this system.

### Content Deletion

Content deletion may be a supported feature. The feature may involve a user going to a profile and identifying a screenshot to edit/delete. The delete feature is called, validates a permission to delete, and calls a remote procedure call (RPC) to delete the content. The RPC deletes the content/image/video. The RPC may return success/fail based on the return result of the database or cloud storage returned through the RPC API. The deletion process may also use a representational state transfer (REST) API, where the REST API helps pass messages between clients and servers.

There may also be an expiration of ephemeral/temporary content. For example, expired content may be automatically purged every 7 days (or at another time interval) to keep the amount of content being stored manageable. For example, it may not be appropriate to store all of the content indefinitely for successful operation of the techniques set forth herein.

### Content Editing

Content editing may be supported for text associated with the request. This content editing may take the form of passing in a request ID and modified text, having the text run through text filter/moderation, and then updating the text associated with the database entry.

### User Reporting

There may be an integration with abuse reports for the new types of content for requests. The reporting may be performed automatically by only sending content for human moderation if there is a high confidence value (per automatic moderation performed using an AI model) that a request is problematic when run through a secondary model check, and/or the request has been reported at least a threshold number of times or a threshold proportion of times compared to total view count for the request against another threshold.

There may also be a reporting cache associated with each request. The user reporting process may include the following. A user reports abuse. The reporting cache gets updated based on the reported event. The automatic moderation is then run via an AI model. The AI model can determine whether to remove or keep the request (producing a validation result). If unsure (the moderation result is associated with a confidence score that is less than a threshold confidence value), the request is sent to a human moderator (for manual moderation).

### Offensive Content Filtering

There may be an aspect of the content moderation to integrate filtering for offensive content into the updated pipeline. Once integrated with automatic moderation for the requests, within the automatic moderation pipeline, resources are downloaded (text/image/video). Then, an offensive content check can be run in the existing path.

### Content Validation

When a screenshot is captured, operations may be performed to validate the origin of the screenshot. For example, a client capture call may be made to capture content. Once the content is captured, the client may hash the capture and make a virtual environment server call (using protected code).

The virtual environment server call may validate that the user is in a particular virtual experience (when the screenshot is captured) and signs a capture hash. This call may return the signature using a server-side secret key. The client stores the signature, experience ID, and image. On a share request, the client passes the image, experience ID, and signature. The server hashes the images and recomputes a signature with an experience ID and secret key. The server then compares signatures. If the signatures match, the validation passes. If the signatures do not match, the validation fails.

There are potential validation alternatives. In some implementations, an image may be validated using an AI model (for example, a trained classifier model), and by using the model to determine if the image matches characteristics of images image from the virtual experience platform.

### Video Moderation

One option for video moderation may be to break the video down into screenshots per second (based on a sampling rate that may permit for a successful launch). The screenshots are then run through an image moderation AI model. Audio may be run through voice moderation (if the audio is present and not muted or otherwise approved).

### Database

The storage for the videos may use a database or may use cloud storage or other type of storage system/technique. For example, the storage may include owner information (such as a user ID and/or a group ID), virtual experience information, content type information, an optional message associated with the request, a creation timestamp, a link to an image in storage, and guidelines to present to a user content that the user is permitted to see.

### Compression/Downsampling

Before storing the images, the images may be compressed to a consistent resolution. Because every screen size is different, storing full size images for every user does not make the most sense. In some implementations, a thumbnail service may be used to thumbnail and downsample the screenshots. This approach may involve changes to a thumbnail service which currently works with assets, to instead work with direct images or with a new requests system as described herein.

There may also be an alternative or additional approach in which the compression is performed at the client. This approach may be optional, because the queries per second (QPS) may still be relatively low (e.g., 10-30 QPS). In some implementations, it may be possible to use, as an example, an image size of 1280 pixels by 720 pixels and a thumbnail size of 320 pixels by 180 pixels.

Further details of various implementations are now described hereinafter.

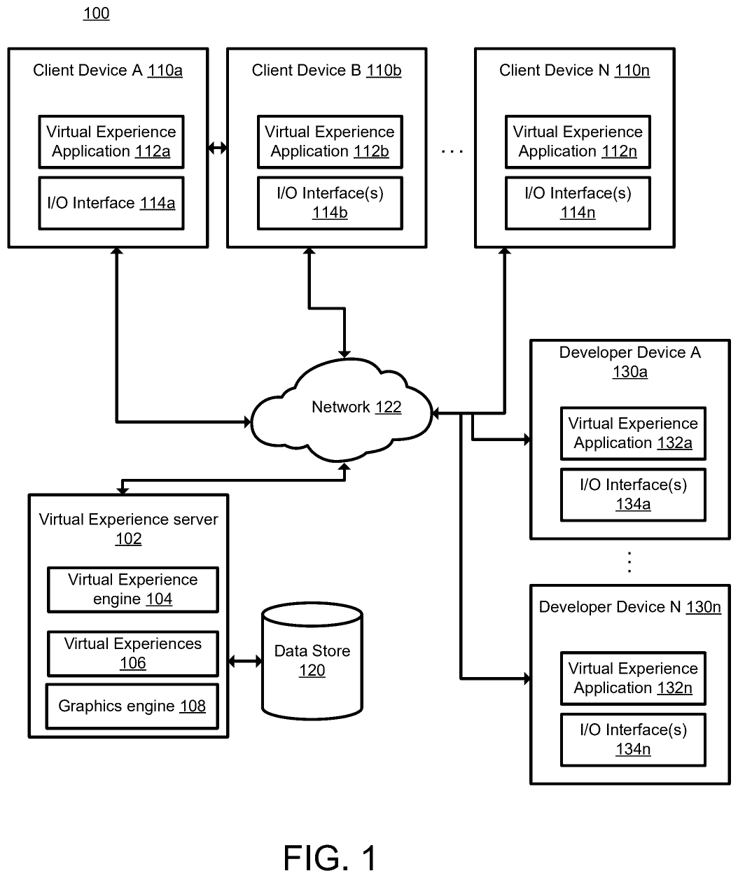

FIG. 1 is a diagram of an example system architecture that facilitates content sharing, in accordance with some implementations. FIG. 1 and the other figures use like reference numerals to identify similar elements. A letter after a reference numeral, such as “110,” indicates that the text refers specifically to the element having that particular reference numeral. A reference numeral in the text without a following letter, such as “110,” refers to any or all of the elements in the figures bearing that reference numeral (e.g., “110” in the text refers to reference numerals “110a,” “110b,” and/or “110n” in the figures).

The system architecture 100 (also referred to as “system” herein) includes online virtual experience server 102, data store 120, client devices 110a, 110b, and 110n (generally referred to as “client device(s) 110” herein), and developer devices 130a and 130n (generally referred to as “developer device(s) 130” herein). Virtual experience server 102, data store 120, client devices 110, and developer devices 130 are coupled via network 122. In some implementations, client devices(s) 110 and developer device(s) 130 may refer to the same or same type of device.

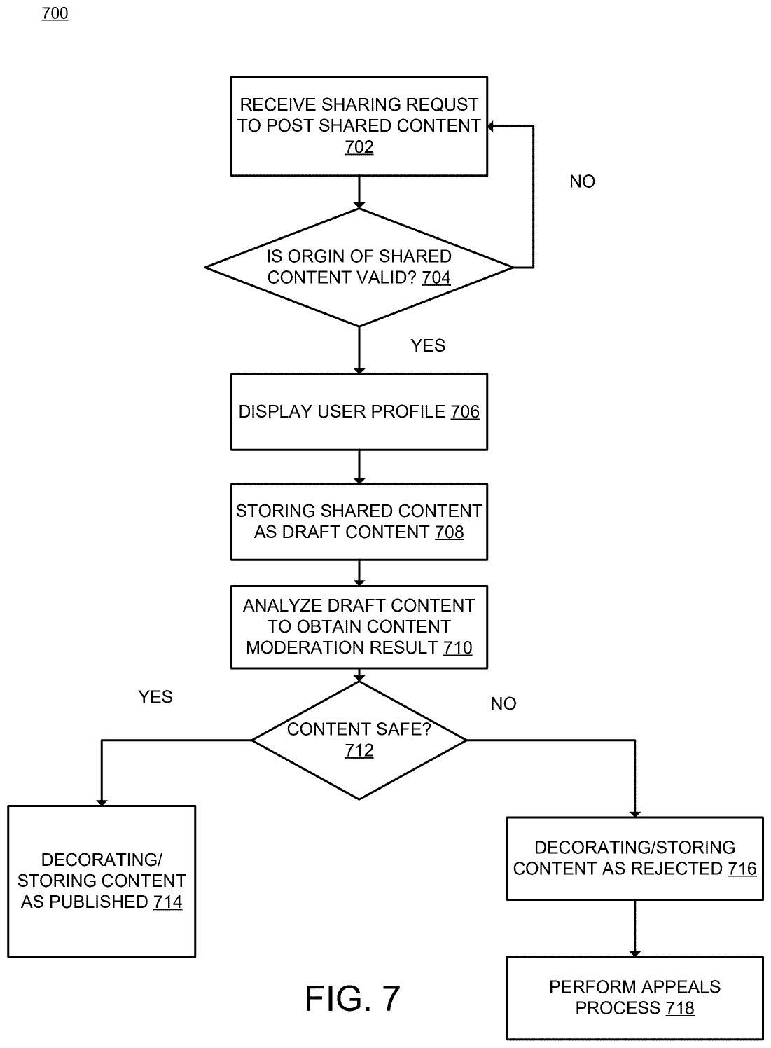

Online virtual experience server 102 can include, among other things, a virtual experience engine 104, one or more virtual experiences 106, and graphics engine 108. In some implementations, the graphics engine 108 may be a system, application, or module that permits the online virtual experience server 102 to provide graphics and animation capability. In some implementations, the graphics engine 108 and/or virtual experience engine 104 may perform one or more of the operations described below in connection with the flowcharts shown in FIGS. 7-11 and/or the various workflows and operations described herein. A client device 110 can include a virtual experience application 112, and input/output (I/O) interfaces 114 (e.g., input/output devices). The input/output devices can include one or more of a microphone, speakers, headphones, display device, mouse, keyboard, game controller, touchscreen, virtual reality consoles, etc.

A developer device 130 can include a virtual experience application 132, and input/output (I/O) interfaces 134 (e.g., input/output devices). The input/output devices can include one or more of a microphone, speakers, headphones, display device, mouse, keyboard, game controller, touchscreen, virtual reality consoles, etc.

System architecture 100 is provided for illustration. In different implementations, the system architecture 100 may include the same, fewer, more, or different elements configured in the same or different manner as that shown in FIG. 1.

In some implementations, network 122 may include a public network (e.g., the Internet), a private network (e.g., a local area network (LAN) or wide area network (WAN)), a wired network (e.g., ethernet network), a wireless network (e.g., an 802.11 network, a Wi-Fi® network, or wireless LAN (WLAN)), a cellular network (e.g., a 5G network, a long term evolution (LTE) network, etc.), routers, hubs, switches, server computers, or a combination thereof.

In some implementations, the data store 120 may be a non-transitory computer readable memory (e.g., random access memory), a cache, a drive (e.g., a hard drive), a flash drive, a database system, or another type of component or device capable of storing data. The data store 120 may also include multiple storage components (e.g., multiple drives or multiple databases) that may also span multiple computing devices (e.g., multiple server computers). In some implementations, data store 120 may include cloud-based storage.

In some implementations, the online virtual experience server 102 can include a server having one or more computing devices (e.g., a cloud computing system, a rackmount server, a server computer, cluster of physical servers, etc.). In some implementations, the online virtual experience server 102 may be an independent system, may include multiple servers, or be part of another system or server.

In some implementations, the online virtual experience server 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience server 102 and to provide a user with access to online virtual experience server 102. The online virtual experience server 102 may also include a website (e.g., a web page) or application back-end software that may be used to provide a user with access to content provided by online virtual experience server 102. For example, users may access online virtual experience server 102 using the virtual experience application 112 on client devices 110.

In some implementations, virtual experience session data are generated via online virtual experience server 102, virtual experience application 112, and/or virtual experience application 132, and are stored in data store 120. With permission from virtual experience participants, virtual experience session data may include associated metadata (e.g., virtual experience identifier(s)); device data associated with the participant(s); demographic information of the participant(s); virtual experience session identifier(s); chat transcripts; session start time, session end time, and session duration for each participant; relative locations of participant avatar(s) within a virtual experience environment; purchase(s) within the virtual experience by one or more participants(s); accessories utilized by participants; etc.

In some implementations, online virtual experience server 102 may be a type of social network providing connections between users or a type of user-generated content system that allows users (e.g., end-users or consumers) to communicate with other users on the online virtual experience server 102, where the communication may include voice chat (e.g., synchronous and/or asynchronous voice communication), video chat (e.g., synchronous and/or asynchronous video communication), or text chat (e.g., 1:1 and/or N:N synchronous and/or asynchronous text-based communication). A record of some or all user communications may be stored in data store 120 or within virtual experiences 106. The data store 120 may be utilized to store chat transcripts (text, audio, images, etc.) exchanged between participants, with appropriate permissions from the players and in compliance with applicable regulations.

In some implementations, the chat transcripts are generated via virtual experience application 112 and/or virtual experience application 132 or and are stored in data store 120. The chat transcripts may include the chat content and associated metadata (e.g., text content of chat with each message having a corresponding sender and recipient(s)); message formatting (e.g., bold, italics, loud, etc.); message timestamps; relative locations of participant avatar(s) within a virtual experience environment, accessories utilized by virtual experience participants, etc. In some implementations, the chat transcripts may include multilingual content, and messages in different languages from different sessions of a virtual experience may be stored in data store 120.

In some implementations, chat transcripts may be stored in the form of conversations between participants based on the timestamps. In some implementations, the chat transcripts may be stored based on the originator of the message(s).

In some implementations of the disclosure, a “user” may be represented as a single individual. Other implementations of the disclosure encompass a “user” (e.g., creating user) being an entity controlled by a set of users or an automated source. For example, a set of individual users federated as a community or group in a user-generated content system may be considered a “user.” In some contexts, a user may be a system administrator or other entity that has privileges/permission that are different from and/or in addition to an end user.

In some implementations, online virtual experience server 102 may be a virtual gaming server. For example, the gaming server may provide single-player or multiplayer games to a community of users that may access as “system” herein) includes online virtual experience server 102, data store 120, client or interact with virtual experiences using client devices 110 via network 122. In some implementations, virtual experiences (including virtual realms or worlds, virtual games, other computer-simulated environments) may be two-dimensional (2D) virtual experiences, three-dimensional (3D) virtual experiences (e.g., 3D user-generated virtual experiences), virtual reality (VR) experiences, or augmented reality (AR) experiences, for example. In some implementations, users may participate in interactions (such as gameplay) with other users. In some implementations, a virtual experience may be experienced in real-time with other users of the virtual experience.

In some implementations, virtual experience engagement may refer to the interaction of one or more participants using client devices (e.g., 110) within a virtual experience (e.g., 106) or the presentation of the interaction on a display or other output device (e.g., 114) of a client device 110. For example, virtual experience engagement may include interactions with one or more participants within a virtual experience or the presentation of the interactions on a display of a client device.

In some implementations, a virtual experience 106 can include an electronic file that can be executed or loaded using software, firmware or hardware configured to present the virtual experience content (e.g., digital media item) to an entity. In some implementations, a virtual experience application 112 may be executed and a virtual experience 106 rendered in connection with a virtual experience engine 104. In some implementations, a virtual experience 106 may have a common set of rules or common goal, and the environment of a virtual experience 106 shares the common set of rules or common goal. In some implementations, different virtual experiences may have different rules or goals from one another.

In some implementations, virtual experiences may have one or more environments (also referred to as “virtual experience environments” or “virtual environments” herein) where multiple environments may be linked. An example of an environment may be a three-dimensional (3D) environment. The one or more environments of a virtual experience 106 may be collectively referred to as a “world” or “virtual experience world” or “gaming world” or “virtual world” or “universe” herein. An example of a world may be a 3D world of a virtual experience 106. For example, a user may build a virtual environment that is linked to another virtual environment created by another user. A character of the virtual experience may cross the virtual border to enter the adjacent virtual environment.

It may be noted that 3D environments or 3D worlds use graphics that use a three-dimensional representation of geometric data representative of virtual experience content (or at least present virtual experience content to appear as 3D content whether or not 3D representation of geometric data is used). 2D environments or 2D worlds use graphics that use two-dimensional representation of geometric data representative of virtual experience content.

In some implementations, the online virtual experience server 102 can host one or more virtual experiences 106 and can permit users to interact with the virtual experiences 106 using a virtual experience application 112 of client devices 110. Users of the online virtual experience server 102 may play, create, interact with, or build virtual experiences 106, communicate with other users, and/or create and build objects (e.g., also referred to as “item(s)” or “virtual experience objects”or “virtual experience item(s)”herein) of virtual experiences 106.

For example, in generating user-generated virtual items, users may create characters, decoration for the characters, one or more virtual environments for an interactive virtual experience, or build structures used in a virtual experience 106, among others. In some implementations, users may buy, sell, or trade virtual experience objects, such as in-platform currency (e.g., virtual currency), with other users of the online virtual experience server 102. In some implementations, online virtual experience server 102 may transmit virtual experience content to virtual experience applications (e.g., 112). In some implementations, virtual experience content (also referred to as “content” herein) may refer to any data or software instructions (e.g., virtual experience objects, virtual experience, user information, video, images, commands, media item, etc.) associated with online virtual experience server 102 or virtual experience applications. In some implementations, virtual experience objects (e.g., also referred to as “item(s)” or “objects” or “virtual objects” or “virtual experience item(s)” herein) may refer to objects that are used, created, shared or otherwise depicted in virtual experiences 106 of the online virtual experience server 102 or virtual experience applications 112 of the client devices 110. For example, virtual experience objects may include a part, model, character, accessories, tools, weapons, clothing, buildings, vehicles, currency, flora, fauna, components of the aforementioned (e.g., windows of a building), and so forth.

It may be noted that the online virtual experience server 102 hosting virtual experiences 106, is provided for purposes of illustration. In some implementations, online virtual experience server 102 may host one or more media items that can include communication messages from one user to one or more other users. With user permission and express user consent, the online virtual experience server 102 may analyze chat transcripts data to improve the virtual experience platform. Media items can include, but are not limited to, digital video, digital movies, digital photos, digital music, audio content, melodies, website content, social media updates, electronic books, electronic magazines, digital newspapers, digital audio books, electronic journals, web blogs, real simple syndication (RSS) feeds, electronic comic books, software applications, etc. In some implementations, a media item may be an electronic file that can be executed or loaded using software, firmware or hardware configured to present the digital media item to an entity.

In some implementations, a virtual experience 106 may be associated with a particular user or a particular group of users (e.g., a private virtual experience), or made widely available to users with access to the online virtual experience server 102 (e.g., a public virtual experience). In some implementations, where online virtual experience server 102 associates one or more virtual experiences 106 with a specific user or group of users, online virtual experience server 102 may associate the specific user(s) with a virtual experience 106 using user account information (e.g., a user account identifier such as username and password).

In some implementations, online virtual experience server 102 or client devices 110 may include a virtual experience engine 104 or virtual experience application 112. In some implementations, virtual experience engine 104 may be used for the development or execution of virtual experiences 106. For example, virtual experience engine 104 may include a rendering engine (“renderer”) for 2D, 3D, VR, or AR graphics, a physics engine, a collision detection engine (and collision response), sound engine, scripting functionality, animation engine, artificial intelligence engine, networking functionality, streaming functionality, memory management functionality, threading functionality, scene graph functionality, or video support for cinematics, among other features. The components of the virtual experience engine 104 may generate commands that help compute and render the virtual experience (e.g., rendering commands, collision commands, physics commands, etc.) In some implementations, virtual experience applications 112 of client devices 110, respectively, may work independently, in collaboration with virtual experience engine 104 of online virtual experience server 102, or a combination of both.

In some implementations, both the online virtual experience server 102 and client devices 110 may execute a virtual experience engine/application (104 and 112, respectively). The online virtual experience server 102 using virtual experience engine 104 may perform some or all the virtual experience engine functions (e.g., generate physics commands, rendering commands, etc.), or offload some or all the virtual experience engine functions to virtual experience engine 104 of client device 110. In some implementations, each virtual experience 106 may have a different ratio between the virtual experience engine functions that are performed on the online virtual experience server 102 and the virtual experience engine functions that are performed on the client devices 110. For example, the virtual experience engine 104 of the online virtual experience server 102 may be used to generate physics commands in cases where there is a collision between at least two virtual experience objects, while the additional virtual experience engine functionality (e.g., generate rendering commands) may be offloaded to the client device 110. In some implementations, the ratio of virtual experience engine functions performed on the online virtual experience server 102 and client device 110 may be changed (e.g., dynamically) based on virtual experience engagement conditions. For example, if the number of users engaging in a particular virtual experience 106 exceeds a threshold number, the online virtual experience server 102 may perform one or more virtual experience engine functions that were previously performed by the client devices 110.

For example, users may be playing a virtual experience 106 on client devices 110, and may send control instructions (e.g., user inputs, such as right, left, up, down, user election, or character position and velocity information, etc.) to the online virtual experience server 102. Subsequent to receiving control instructions from the client devices 110, the online virtual experience server 102 may send experience instructions (e.g., position and velocity information of the characters participating in the group experience or commands, such as rendering commands, collision commands, etc.) to the client devices 110 based on control instructions. For instance, the online virtual experience server 102 may perform one or more logical operations (e.g., using virtual experience engine 104) on the control instructions to generate experience instruction(s) for the client devices 110. In other instances, online virtual experience server 102 may pass one or more or the control instructions from one client device 110 to other client devices (e.g., from client device 110a to client device 110b) participating in the virtual experience 106. The client devices 110 may use the experience instructions and render the virtual experience for presentation on the displays of client devices 110.

In some implementations, the control instructions may refer to instructions that are indicative of actions of a user's character within the virtual experience. For example, control instructions may include user input to control action within the experience, such as right, left, up, down, user selection, gyroscope position and orientation data, force sensor data, etc. The control instructions may include character position and velocity information. In some implementations, the control instructions are sent directly to the online virtual experience server 102. In other implementations, the control instructions may be sent from a client device 110 to another client device (e.g., from client device 110b to client device 110n), where the other client device generates experience instructions using the local virtual experience engine 104. The control instructions may include instructions to play a voice communication message or other sounds from another user on an audio device (e.g., speakers, headphones, etc.), for example voice communications or other sounds generated using the audio spatialization techniques as described herein.

In some implementations, experience instructions may refer to instructions that enable a client device 110 to render a virtual experience, such as a multiparticipant virtual experience. The experience instructions may include one or more of user input (e.g., control instructions), character position and velocity information, or commands (e.g., physics commands, rendering commands, collision commands, etc.).

In some implementations, characters (or virtual experience objects generally) are constructed from components, one or more of which may be selected by the user, that automatically join together to aid the user in editing.

In some implementations, a character is implemented as a 3D model and includes a surface representation used to draw the character (also known as a skin or mesh) and a hierarchical set of interconnected bones (also known as a skeleton or rig). The rig may be utilized to animate the character and to simulate motion and action by the character. The 3D model may be represented as a data structure, and one or more parameters of the data structure may be modified to change various properties of the character, e.g., dimensions (height, width, girth, etc.); body type; movement style; number/type of body parts; proportion (e.g., shoulder and hip ratio); head size; etc. is provided as illustration. In some implementations, any number of client devices 110 may be used.

One or more characters (also referred to as an “avatar” or “model” herein) may be associated with a user where the user may control the character to facilitate a user's interaction with the virtual experiences 106.

In some implementations, a character may include components such as body parts (e.g., hair, arms, legs, etc.) and accessories (e.g., t-shirt, glasses, decorative images, tools, etc.). In some implementations, body parts of characters that are customizable include head type, body part types (arms, legs, torso, and hands), face types, hair types, and skin types, among others. In some implementations, the accessories that are customizable include clothing (e.g., shirts, pants, hats, shoes, glasses, etc.), weapons, or other tools.

In some implementations, for some asset types (e.g., shirts, pants, etc.), the online virtual experience platform may provide users access to simplified 3D virtual object models that are represented by a mesh of a low polygon count (e.g., between about 20 and about 30 polygons).

In some implementations, the user may also control the scale (e.g., height, width, or depth) of a character or the scale of components of a character. In some implementations, the user may control the proportions of a character (e.g., blocky, anatomical, etc.). It may be noted that in some implementations, a character may not include a character virtual experience object (e.g., body parts, etc.) but the user may control the character (without the character virtual experience object) to facilitate the user's interaction with the virtual experience (e.g., a puzzle game where there is no rendered character game object, but the user still controls a character to control in-game action).

In some implementations, a component, such as a body part, may be a primitive geometrical shape such as a block, a cylinder, a sphere, etc., or some other primitive shape such as a wedge, a torus, a tube, a channel, etc. In some implementations, a creator module may publish a user's character for view or use by other users of the online virtual experience server 102. In some implementations, creating, modifying, or customizing characters, other virtual experience objects, virtual experiences 106, or virtual experience environments may be performed by a user using an I/O interface (e.g., developer interface) and with or without scripting (or with or without an application programming interface (API)). It may be noted that for purposes of illustration, characters are described as having a humanoid form. It may further be noted that characters may have any form such as a vehicle, animal, inanimate object, or other creative form.

In some implementations, the online virtual experience server 102 may store characters created by users in the data store 120. In some implementations, the online virtual experience server 102 maintains a character catalog and virtual experience catalog that may be presented to users. In some implementations, the virtual experience catalog includes images of virtual experiences stored on the online virtual experience server 102. In addition, a user may select a character (e.g., a character created by the user or other user) from the character catalog to participate in the chosen virtual experience. The character catalog includes images of characters stored on the online virtual experience server 102. In some implementations, one or more of the characters in the character catalog may have been created or customized by the user. In some implementations, the chosen character may have character settings defining one or more of the components of the character.

In some implementations, a user's character (e.g., avatar) can include a configuration of components, where the configuration and appearance of components and more generally the appearance of the character may be defined by character settings. In some implementations, the character settings of a user's character may at least in part be chosen by the user. In other implementations, a user may choose a character with default character settings or character setting chosen by other users. For example, a user may choose a default character from a character catalog that has predefined character settings, and the user may further customize the default character by changing some of the character settings (e.g., adding a shirt with a customized logo). The character settings may be associated with a particular character by the online virtual experience server 102.

In some implementations, the client device(s) 110 may each include computing devices such as personal computers (PCs), mobile devices (e.g., laptops, mobile phones, smart phones, tablet computers, or netbook computers), network-connected televisions, gaming consoles, etc. In some implementations, a client device 110 may also be referred to as a “user device.” In some implementations, one or more client devices 110 may connect to the online virtual experience server 102 at any given moment. It may be noted that the number of client devices 110 is provided as illustration. In some implementations, any number of client devices 110 may be used.

In some implementations, each client device 110 may include an instance of the virtual experience application 112, respectively. In one implementation, the virtual experience application 112 may permit users to use and interact with online virtual experience server 102, such as control a virtual character in a virtual experience hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, virtual experience program, or a gaming program) that is installed and executes local to client device 110 and allows users to interact with online virtual experience server 102. The virtual experience application may render, display, or present the content (e.g., a web page, a media viewer) to a user. In an implementation, the virtual experience application may also include an embedded media player (e.g., a Flash® or HTML5 player) that is embedded in a web page.

According to aspects of the disclosure, the virtual experience application may be an online virtual experience server application for users to build, create, edit, and upload content to the online virtual experience server 102 as well as interact with online virtual experience server 102 (e.g., engage in virtual experiences 106 hosted by online virtual experience server 102). As such, the virtual experience application may be provided to the client device(s) 110 by the online virtual experience server 102. In another example, the virtual experience application may be an application that is downloaded from a server.

In some implementations, each developer device 130 may include an instance of the virtual experience application 132, respectively. In one implementation, the virtual experience application 132 may permit a developer user(s) to use and interact with online virtual experience server 102, such as control a virtual character in a virtual experience hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, virtual experience program, or a gaming program) that is installed and executes local to developer device 130 and allows users to interact with online virtual experience server 102. The virtual experience application may render, display, or present the content (e.g., a web page, a media viewer) to a user. In an implementation, the virtual experience application may also include an embedded media player (e.g., a Flash® or HTML5 player) that is embedded in a web page.

According to aspects of the disclosure, the virtual experience application 132 may be an online virtual experience server application for users to build, create, edit, and upload content to the online virtual experience server 102 as well as interact with online virtual experience server 102 (e.g., provide and/or engage in virtual experiences 106 hosted by online virtual experience server 102). As such, the virtual experience application may be provided to the developer device(s) 130 by the online virtual experience server 102. In another example, the virtual experience application 132 may be an application that is downloaded from a server. Virtual experience application 132 may be configured to interact with online virtual experience server 102 and obtain access to user credentials, user currency, etc. for one or more virtual experiences 106 developed, hosted, or provided by a virtual experience developer.

In some implementations, a user may login to online virtual experience server 102 via the virtual experience application. The user may access a user account by providing user account information (e.g., username and password) where the user account is associated with one or more characters available to participate in one or more virtual experiences 106 of online virtual experience server 102. In some implementations, with appropriate credentials, a virtual experience developer may obtain access to virtual experience virtual objects, such as in-platform currency (e.g., virtual currency), avatars, special powers, accessories, that are owned by or associated with other users.

In general, functions described in one implementation as being performed by the online virtual experience server 102 can also be performed by the client device(s) 110, or a server, in other implementations if appropriate. In addition, the functionality attributed to a particular component can be performed by different or multiple components operating together. The online virtual experience server 102 can also be accessed as a service provided to other systems or devices through suitable application programming interfaces (APIs), and thus is not limited to use in websites.

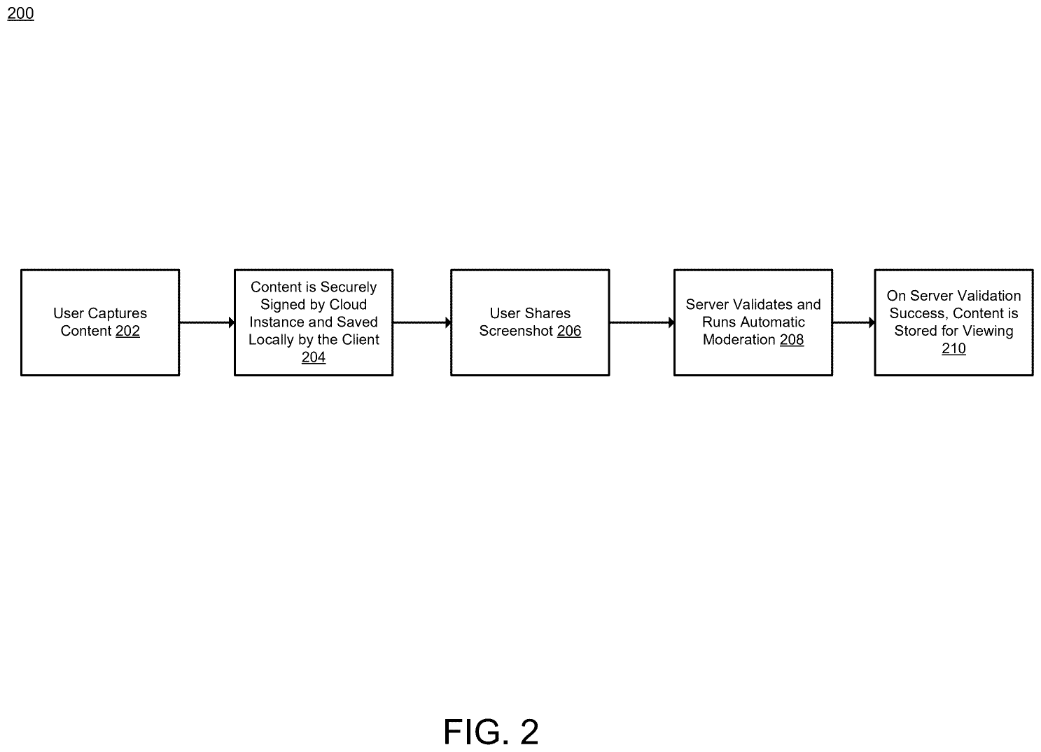

FIG. 2 is a diagram illustrating a workflow 200 for capturing and sharing content, in accordance with some implementations. Workflow 200 may begin at block 202.

At block 202, a user captures content. In some implementations, a user interacting with a virtual experience provided by a virtual environment may capture in-game media content (or other type of virtual experience content) corresponding to the user's interaction with the virtual experience. For example, the content may include one or more captured screenshots (with or without images), videos (with or without audio), audio, text (such as subtitles etc.), or other types of content.

Such content capture may leverage various techniques provided by the virtual environment for content capture. For example, the content capture functionality may use techniques to capture and store the content, as well as information about the content, such as the experience the screenshot was captured in, and other additional user information. Block 202 may be followed by block 204.

At block 204, the content is securely signed by a cloud instance and saved locally by the client. Such secure signing permits the process to validate the content as part of a sharing process. Block 204 may be followed by block 206.

At block 206, the screenshot is shared by the user. For example, the user may identify another user of the virtual environment, who may participate in the same virtual experience or not, to whom the screenshot is to be sent. A similar operation may apply to video content. Block 206 may be followed by block 208.

At block 208, the server validates and runs automatic moderation on the content. The server performs the validation to confirm that the content is from an authentic source. The moderation (which is made automatic using techniques provided by the server) attempts to ensure that the content, once validated and moderated, is also safe content. For example, the moderation may attempt to ensure that the content does not violate policies of the virtual environment or the virtual experience. For example, if the content is not suitable for a receiving user given the receiving user's age, the content may not pass moderation. Block 208 may be followed by block 210.

At block 210, in response to a server validation success, the content is stored for viewing. Because the content has been confirmed as being authentic and valid, the content may be viewed by the receiving user.

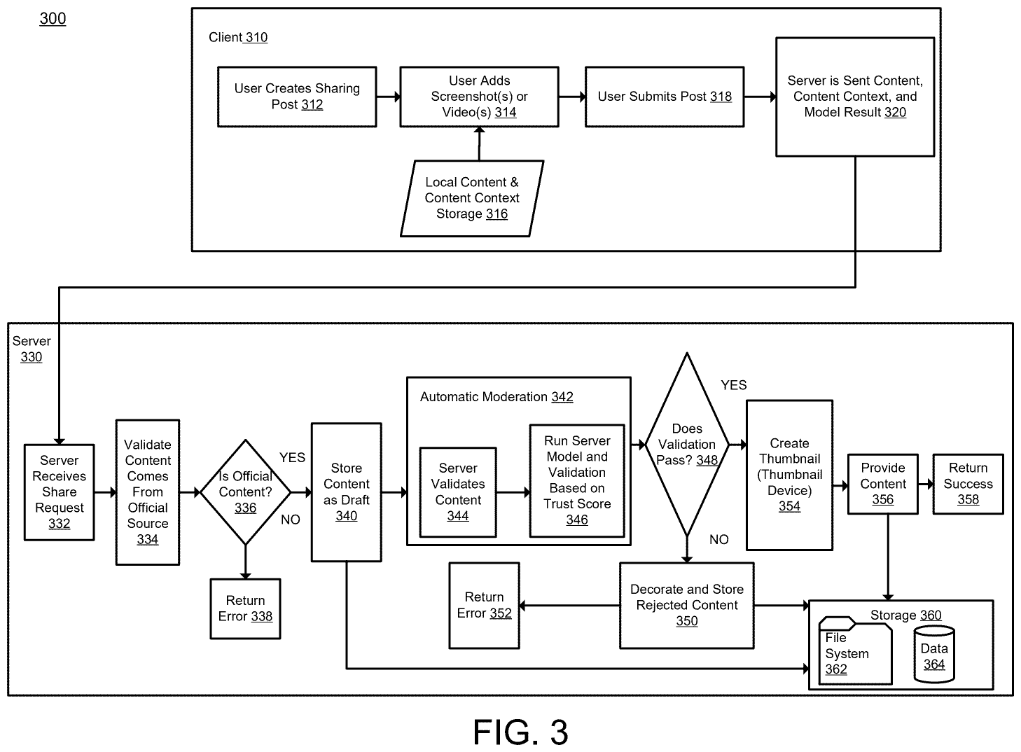

FIG. 3 is another diagram illustrating another workflow 300 for capturing and sharing content, in accordance with some implementations. Workflow 300 may begin at block 312. Workflow 300 includes aspects of a client 310 and aspects of a server 330 in some implementations. The client 310 may be embodied by or may reside at the client device 110 of FIG. 1, and the server 330 may be the server 102 of FIG. 1, for example.

Client 310 performs several operations. At block 312, a user creates a sharing post. The user may, from the frontend (for example, a user interface), start the process of creating a post. For example, the user may use a share button or a link from a profile page. Block 312 may be followed by block 314.

At block 314, a user adds content such as screenshot(s) and/or video(s). The screenshot(s) and/or video(s) may be accessed from a local content and content context storage 316. When a post is being created, content is added to the post.

For some entry points, such as the share button, the content may be pre-populated. For other entry points, for example a profile link, a user may select the content the user may like to share. Functionality to permit the user to edit the content before posting, such as cropping, adding text, or adding content may also be provided to the user. Block 314 may be followed by block 318.

At block 318, the post is submitted by the user. The user may request posting the image or other content. At this point, the call may be handled synchronously (if there are sufficient computing resources), but if the content is video or something similar with large space and computing demands, the call may be handled asynchronously and the user notified once the content has been posted. Block 318 may be followed by block 320.

At block 320, the server 330 is sent content, content context, and a model result. At this point, the client may actually send the content to be shared in a post over to the server. This post may include the content itself (e.g., screenshots and/or video) and the game/contextual information associated with the screenshot. At block 320, the portion of the workflow 300 performed by the client 310 may be complete, such that the remainer of workflow 300 is performed by the server 330. Block 320 may be followed by block 332.

At block 332, the server 330 receives the share request. When the server 330 gets the request, the server 330 may do initial validation. For example, such validation could establish if the user is authenticated, whether the context of the request correct, etc. Block 332 may be followed by block 334.

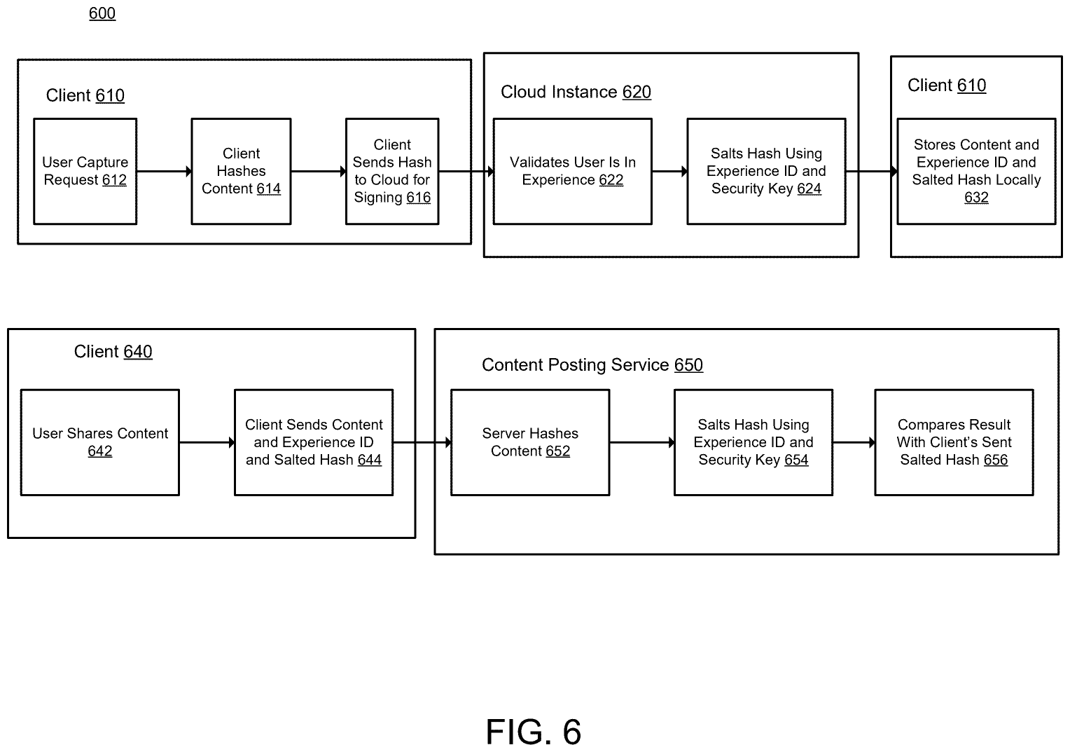

At block 334, the content is validated if the content comes from an official source. This operation may validate that the content was generated from an authentic client. For example, additional aspects of such validation may be presented in FIG. 6. Block 334 may be followed by block 336.

At block 336, it is determined if the content is official or not, based on the results of block 334. Official content is content that has been validated as coming from an official source. If so (the content is official), block 336 is followed by block 340, which processes the content accordingly. If not (the content is not official), block 336 is followed by block 338.

At block 338, an error is returned to the client 310. Because the content is not official, the workflow 300 is unable to proceed further.

At block 340, the content is stored in an object storage service as a draft. This object storage service is used in this manner so that the workflow can more effectively manage the content using the object through the remainder of the image processing systems. The object storage may provide a scalable, secure, and durable way to store and retrieve data from anywhere on the web or other network. Such an object storage service may use objects within buckets/folders and use keys to identify the objects. Block 340 may be followed by automatic moderation at a block 342. Block 340 may use various techniques to store the content. For example, block 340 may interact with storage 360. Storage 360 may include various types of storage, such as a file system 362 and/or a data repository 364.

There may be an automatic moderation (block 342) process. Automatic moderation at block 342 process includes block 344 and block 346. Using automatic moderation at block 342, some implementations run the images (or video or other content) through a moderation pipeline. This may include an alternative pipeline that has been augmented with screenshot specific content.

At block 344, a server validates the content using a check for abusive content (such as content inappropriate for children or other users under 18 years or 21 years of age, as examples). Block 344 may be followed by block 346.

At block 346, a server model and validation is run, and there is a validation based on a trust score provided from block 344. Block 346 may be followed by block 348.

At block 348, it is determined if a validation passes. If so (the validation passes), block 348 is followed by block 354. If not, and the validation does not pass, block 348 is followed by block 350.

At block 350, rejected content is decorated (as discussed herein) and stored as rejected. The rejection can be appealed. For example, block 350 may use a storage 360, and store the decorated rejected content in storage 360, such as a file system 362 and/or a data repository 364. Block 350 may be followed by block 352.

At block 352, an error is returned. It may be noted that the error returned in block 352 may differ from that returned in block 338. In block 338, the issue is that the content is not official, so workflow 300 does not proceed further. In block 352, the error is that the content does not pass validation. Thus, the content may still be rejected, decorated, and stored, and an appropriate error message provided.

At block 354, a thumbnail for the content is created. For example, the system may call a thumbnail system to resize the image (if necessary) and create a thumbnail for the image. Such a thumbnail may be created using a thumbnail device, a thumbnail program, or a thumbnail technique.

Creating a thumbnail may include opening the original image (which may be a full-sized image file in a format such as JPEG, PNG, or GIF). If the content is video, a thumbnail may be created based on a representative frame, which may be captured and processed. For example, a thumbnail size may be defined (a pixel height by a pixel width). The pixel height and the pixel width may have equal proportions to that of the original image, but this is not mandatory, and other proportions are possible. Then, a resampling technique may be used to shrink the image.

This process calculates new pixel values for the smaller dimensions to preserve the image's overall appearance. Without proper resampling, the resulting thumbnail may appear distorted or pixelated. In addition to resizing, the thumbnailing may involve cropping, adjusting image properties (brightness, contrast, saturation, etc.), removing background, and adding text/graphics. The thumbnailing may also change format, such as to a compressed format like JPEG. Block 354 may be followed by block 356.

At block 356, the content is provided to the server. For example, the content is stored, such as in storage 360, such as in file system 362 and/or data repository 364. Block 356 may be followed by block 358. The storage may also include decoration of the content (as discussed herein).

At block 358, a success is returned. This success indicates that the content is official and has passed validation, and that appropriate actions have been taken. For example, a status of the content may be changed from draft to submitted, indicating that workflow 300 is complete.

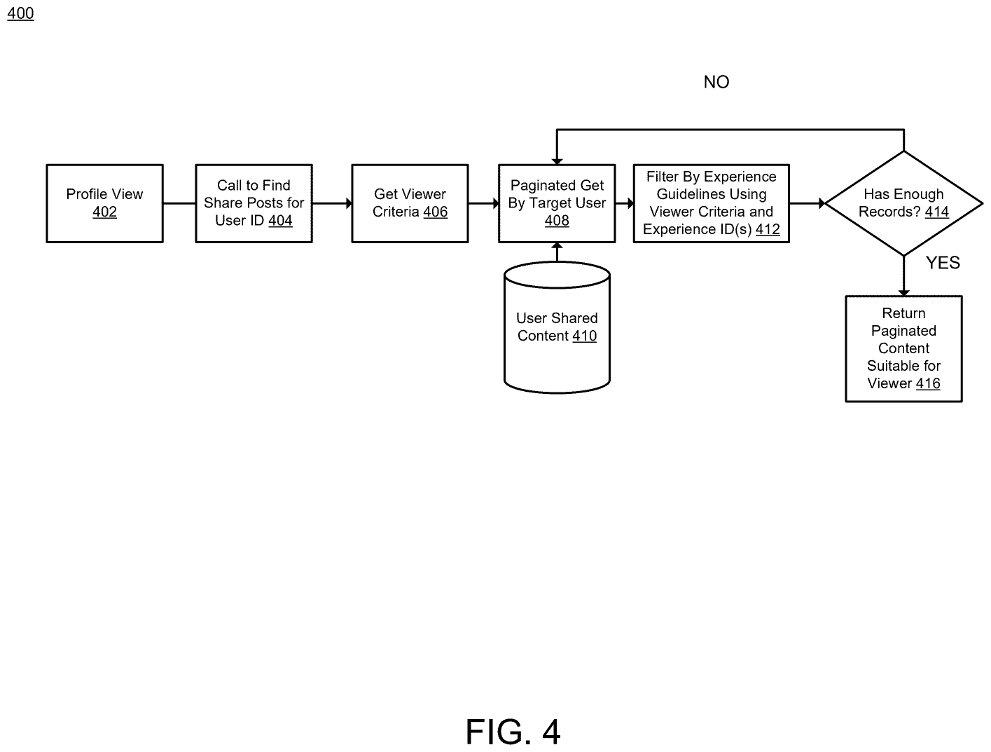

FIG. 4 is a diagram illustrating a workflow 400 for viewing content, in accordance with some implementations. Workflow 400 may begin at block 402.

At block 402, a profile is viewed. Here, a user views the profile of a target user (who can be the same user). This operation may be integrated into the profile platform as part of serving the posts. Block 402 may be followed by block 404.

At block 404, a call is made to find share posts for the user ID of the target user. Such a call finds all user shared content, which may be paginated, by time. Block 404 may be followed by 406.

At block 406, viewer criteria is obtained. The service may get the criteria associated with the user. For example, obtaining the criteria may include retrieving the user's age and location, and comparing that information with what content the user can consume. In some implementations, this is limited to fetching data from a certain time window, such as the last 12 hours, the last 24 hours, the last week, etc. There may also be information about user relationships, such as friend relationships, follower relationships, etc. Block 406 may be followed by block 408.

At block 408, a get operation (such as a paginated get) is performed by the target user. The content accessed may be retrieved from user shared content 410. Block 408 may be followed by block 412.

At block 412, the content is filtered by experience guidelines, using viewer criteria and corresponding experience ID(s) are provided to permit the frontend to decorate the posts. Block 412 is followed by block 414.

At block 414, it is determined if there have been enough records. If so (there are enough records), block 414 is followed by block 416. If not (there are not enough records), block 416 is followed by block 408 to retrieve more records.

At block 416, paginated content suitable for the viewer (for example, the target user) is returned, as retrieved previously in workflow 400 in FIG. 4.

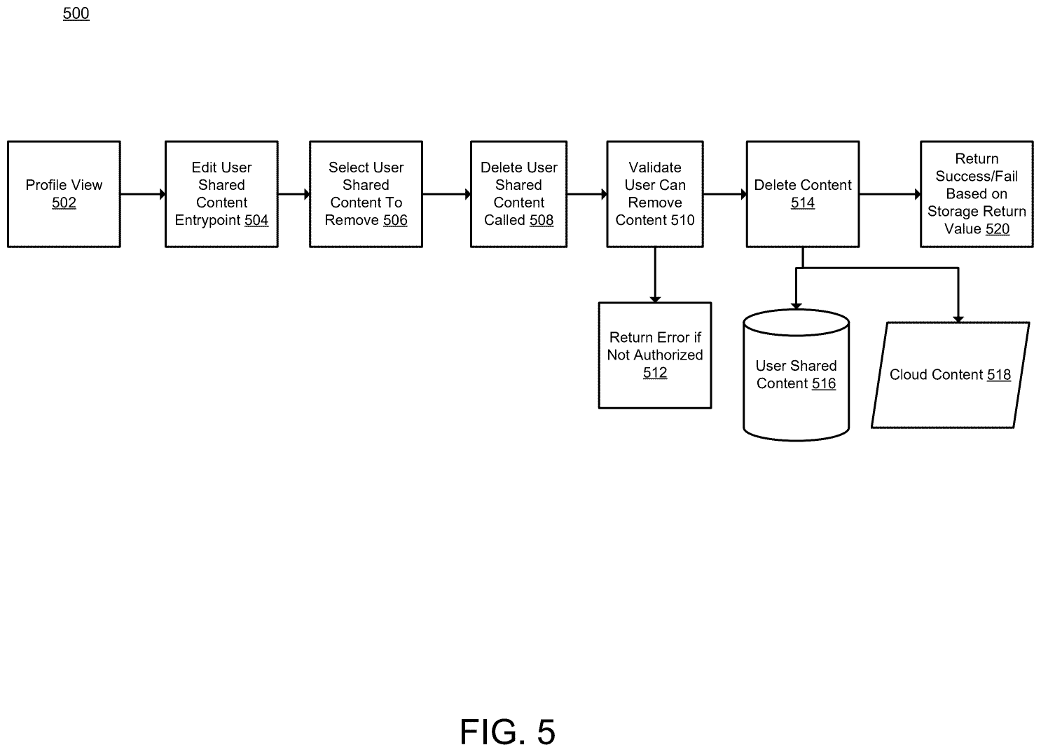

FIG. 5 is a diagram illustrating a workflow 500 for user content deletion, in accordance with some implementations. Workflow 500 may begin at block 502.

At block 502, a profile is viewed. Here, a user accesses a corresponding profile, which permits the user to manage content associated with that profile. Block 502 may be followed by block 504.

At block 504, a user shared content entry point is provided. If there is one piece of screenshot under consideration, block 504 may be followed by block 508. If there are multiple pieces of content, block 504 may be followed by block 506.

At block 506, user content to remove is selected. For example, the user may be provided with an interface that permits the user to mark user content for deletion. Block 506 may be followed by block 508.

At block 508, a function to delete user shared content is called. The function is a function associated with the content that deletes the content. Block 508 may be followed by block 510.

At block 510, it is validated if the user can remove the content. For example, the user and content may be associated with metadata such as access privileges that establish what a given user can remove and which users can remove given content. If the user is not authorized to remove the content, block 510 is followed by block 512. If the user is authorized to remove the content, block 510 is followed by block 514.

At block 512, an error is returned. Such an error indicates that, while the user has tried to remove content, the content cannot be removed by that user because the user is not authorized to remove that content, for example. Hence, workflow 500 ends at block 512.

At block 514, the selected content is deleted. In order to delete such content, the deleting interacts with user shared content 516 and/or cloud content 518 using an API such as a remote procedure call. Such a remote procedure call acts to permit a client to execute a function on a remote server as if the function were a local function within the client's own application. Block 514 may be followed by block 520.

At block 520, a success/fail result for the user shared content 516 (which may be a database) or the cloud content 518 is returned. Such a result informs the user of the result of the user's delete request.

FIG. 6 is a diagram illustrating a workflow 600 for validating that content comes from a designated source, in accordance with some implementations. Workflow 600 may begin at block 612. Workflow 600 is performed in two stages. The first stage is performed by a client 610 in interaction with a cloud instance 620. The second stage is performed by a client 640 (which may or may not be the same as client 610) in interaction with a content posting service 650. The clients 610 and 640 may reside at or be embodied by the client devices 110 of FIG. 1. The cloud instance 520 and the content posting service 650 may be provided by the server 102 or other device(s) that may reside in the system 100 of FIG. 1.

At block 612, client 610 receives a user capture request. The client 610 captures the content accordingly. For example, the content may be a captured screenshot, or a still image captured from a video. Block 612 may be followed by block 614.

At block 614, the client 610 hashes the content. A variety of hashes may be used to hash the content. Such hashing may use protected code. Such protected code may include software that has been protected using a software utility or another form of protection, which converts executable code into a unique virtual machine language, making the code highly difficult for humans and automatic tools to analyze and reverse-engineer. This protects the code, preventing cheating, and avoiding tampering. Block 614 may be followed by block 616.

At block 616, the client 610 sends the hash to the cloud instance 620 for signing. For example, this sending may be done using a cloud instance function call. Block 616 may be followed by block 622.

At block 622, is the cloud instance 620 validates that the user is in the experience. For example, the cloud instance function call performs this validation. Block 622 may be followed by block 624.

At block 624, the hash is salted using an experience ID and a security key. Salting a hash is a security measure where a unique, random value (the “salt”) is added to a password before it's hashed. This prevents attackers from using pre-computed hash tables (like rainbow tables) to crack passwords, as each password may have a unique hash due to the unique salt. After the salting, the salted hash is returned to the client 610. The call also returns the signature using a server-side secret key. Block 624 may be followed by block 632.

At block 632, the salted hash based on the content and experience ID may be stored locally. The client 610 stores the signature, experience ID, and image. At this point, the content is ready for content posting. The content posting may begin at block 642.

At block 642, a user shares content. Block 642 may be performed at a client 640. Client 640 may be the same client as client 610, or client 640 may be a different client. Block 642 may be followed by block 644.

At block 644, the client sends content, an experience ID, and the salted hash to a content posting service 650 (which may reside at a server). Such sending occurs in response to the share request provided in block 642. Block 644 may be followed by block 652.

At block 652, the server hashes the content again. The hashing technique used by the server may be the same hashing technique that the client uses. Having the hashing technique be the same enables the server to take the same input as the client and generate the same output, so that the results may be checked properly by confirming that the results match. Block 652 may be followed by block 654.

At block 654, the hash is salted using the experience ID and the security key. The server recomputes the signature with the experience ID and the secret key. Block 654 may be followed by block 656.

At block 656, the result of block 654 is compared with the salted hash sent by the client. If these results match, the validation is successful. If these results do not match, the validation is unsuccessful.

FIG. 7 is a flowchart illustrating a method 700 to share content, in accordance with some implementations. Method 700 may begin at block 702.

At block 702, a sharing request to post shared content is received. In some implementations, the request may be a sharing request received from a user via a client device to post shared content to the server. The shared content may include video content, one or more screenshots, audio content, or a combination of these types of content or other types of content. While the content is not actually in a shared state until after it is validated and moderated, the term shared content refers to the shareable content that a user requests the sharing of, for convenience of reference, throughout this disclosure. Block 702 may be followed by block 704.

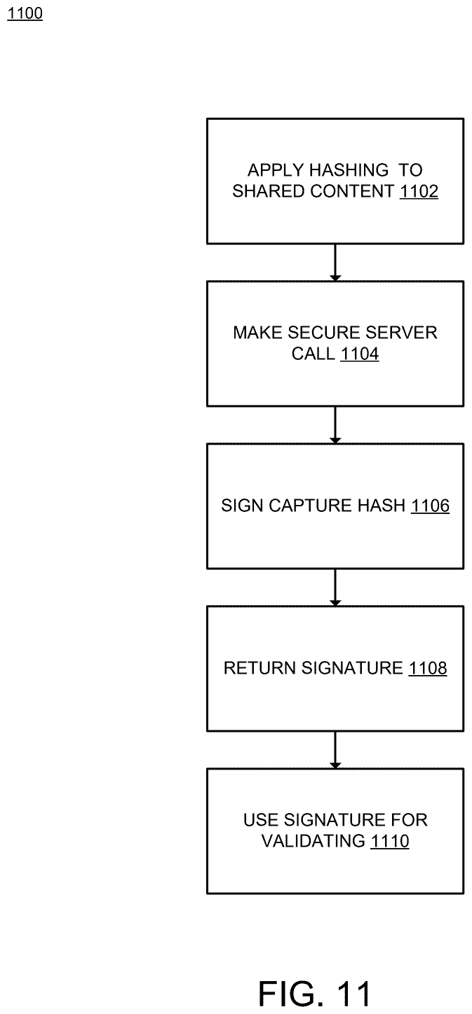

At block 704, it is determined if the origin of the shared content is valid. Aspects of such validation are presented in the discussion of FIG. 6 and FIG. 11. If not (the origin of the shared content is not valid), block 704 may be followed by block 702 and another sharing request is received or awaited. Optionally, there may also be an error message indicating that the shared content does not have a valid origin. If so (the origin of the shared content is valid), block 704 may be followed by block 706.

At block 706, a user profile may be displayed. Here, in response to validating that the origin of the shared content is the valid origin, the shared content may be displayed as part of a user profile of an originating user (for example, a sharer user) that provided the shared content. The user profile may be based on an age of the originating user, a location of the originating user, or a combination of this information. Optionally, other information may be included in the user profile. The use of this user profile information is to establish guidelines for which content the user may be able to access. Block 706 is optional, and block 704 may be followed by block 708 (without displaying a user profile). Block 706 may be followed by block 708.

At block 708, shared content is stored as draft content. For example, the server may store the shared content as draft content. The draft content is stored temporarily, until a safety or other standard/criteria of the draft content may be established. Block 708 may be followed by block 710.

At block 710, the draft content may be analyzed to obtain a content moderation result. For example, the virtual environment may provide such a content moderation result. The automatic moderation system may filter content and behavior across the platform.

The automatic moderation may enforce community standards and provide a safe environment for users of the virtual environment. The automatic moderating may include chat filtering, asset filtering, voice chat filtering, and username screening. The chat filtering may use moderation software to filter text in various languages to block profanity, as well as other malicious contexts, scams, and other efforts to bypass the filter. The asset filtering may scan content (e.g., image, audio, video, or other types of content) for inappropriate content. Similar inappropriate content may be identified using voice chat filtering and username screening. Block 710 may be followed by block 712.

At block 712, it is determined if the content is safe, based on the result of block 710. Safe content may include content that, when analyzed using the automatic moderation, does not include content that violates policies of the virtual environment. In some implementations, an approach is used such that the content moderation result includes a safety score associated with the draft content.

The method may further tag for human moderation draft content that has a safety score lower than a threshold value (e.g., the score indicates possibly unsafe draft content), and the human moderator acts to make the determination if the content is to be considered safe or unsafe. If the content is safe, block 712 is followed by block 714. If the content is not safe, block 712 is followed by 716.

At block 714, the content is decorated and stored as published. For example, the content may be stored in the cloud and/or in a database or another form of storage. Decorating the content may include customizing and enhancing the visual appearance of the content based on input from the user. There may also be an appropriate acknowledgement provided to the user.

At block 716, the content is stored as rejected. The rejected content may also be decorated, where the decorating is analogous to the decorating that occurs in block 714. There may also be an appropriate acknowledgement. Block 716 may also be followed by block 718, for an appeals process. The appeals process at block 718 is optional in some implementations.

At block 718, an appeals process occurs. The appeals process may permit a user that did not pass moderation to point out an error, such as to a human moderator, and to correct the result of the moderation. Posts that fail automatic moderation (as well as manual moderation) may be eligible for appeal.

The appeal process may be as follows. The appeal process may be triggered by a user requesting an appeal directly after a failed upload, or a user may be notified that content for the user was removed and may appeal accordingly. If an appeal occurs, it may be possible to re-run automatic moderation based on a higher confidence score to see if that changes the results of the appeal.

If the automatic moderation indicates that the content is still rejected, the appeal may fail. If the new automatic moderation based on the higher confidence score changes the results, the content may be sent to manual moderation. If the manual moderation approves, the content is approved on appeal, and if the manual moderation rejects, the content is rejected on appeal.

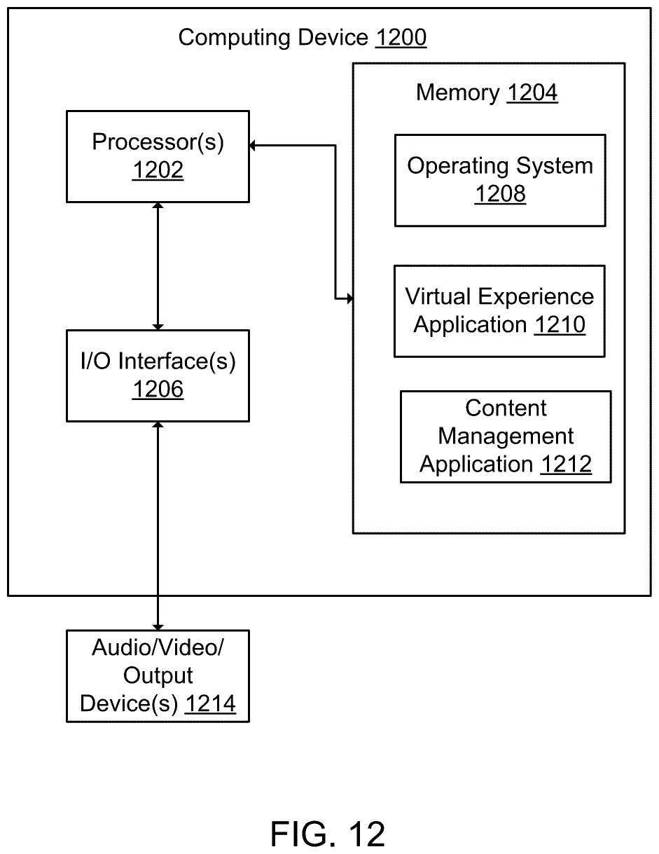

While FIG. 7 illustrates several operations provided in a certain order for carrying out method 700, it may be noted that there may be a variety of modifications to method 700 and the various other methods described herein. For example, other operations may be added, operations may be omitted, operations may be modified, operations may be replaced by other operations, operations may be supplemented by other operations, operations may be combined, or the order of operations may be varied. For example, the sequence of certain operations may be changed, or some of the operations may be carried out in parallel, as appropriate. Various operations as illustrated in method 700 may be implemented by various hardware and/or software. For example, FIG. 1 and FIG. 12 illustrate various components that may implement the various operations provided in method 700 or in the other methods described herein, such as by being programmed using various appropriate software to configure the hardware to carry out method 700 or in the other methods described herein.

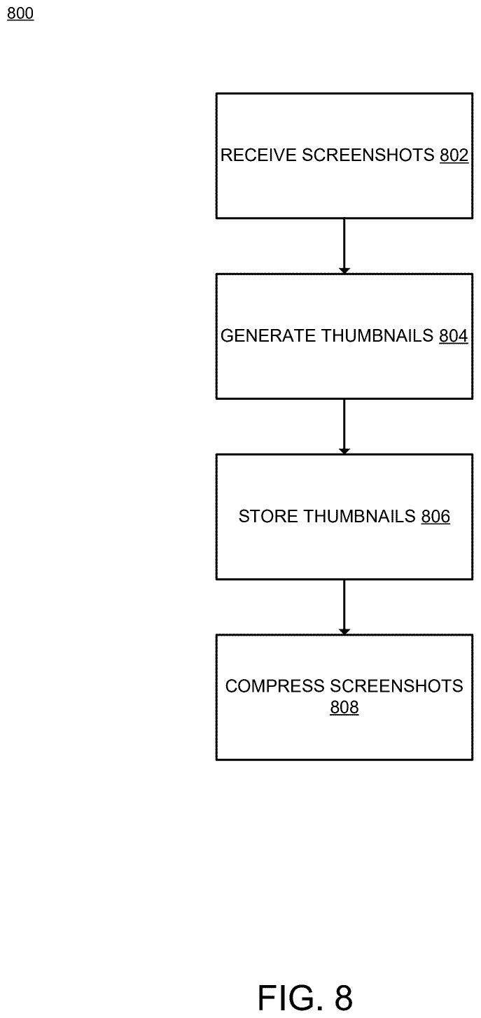

FIG. 8 is a flowchart illustrating a method 800 to manage screenshots, in accordance with some implementations. Method 800 may begin at block 802.

At block 802, screenshots are received as the content. The screenshots may be bitmapped images (which may be full-sized image files in a format such as JPEG, PNG, or GIF) or other types of content. Block 802 may be followed by block 804.

At block 804, thumbnails are generated from the screenshots. As discussed, generating thumbnails may begin with the screenshots, and use various forms of sampling to generate the thumbnails. Block 804 may be followed by block 806.

At block 806, the thumbnails generated in block 804 are stored. Such thumbnails may be of use when accessing the screenshots. For example, a user interface including the thumbnails may provide a user-friendly way to access the screenshots, such as by presenting a list or a matrix of thumbnails that can be used to access the screenshots corresponding to the thumbnails. Block 806 may be followed by block 808.

At block 808, the screenshots may be compressed. The compression is to occur prior to storing the screenshots, so that the screenshots occupy less space when stored. For example, the compression may use lossless techniques such as run-length encoding (RLE), Lempel-Ziv-Welch (LZW), or Huffman coding/arithmetic coding or other compression technique.

Alternatively or additionally, the compression may use lossy techniques such as a discrete cosine transform (DCT), wavelet compression, or other types of transform coding. The compression may also include the use of more efficient formats, resizing an image, or other optimizations. The compression of the screenshots may optionally occur before block 804 and block 806. In such a case, the thumbnails are obtained from the compressed screenshots.

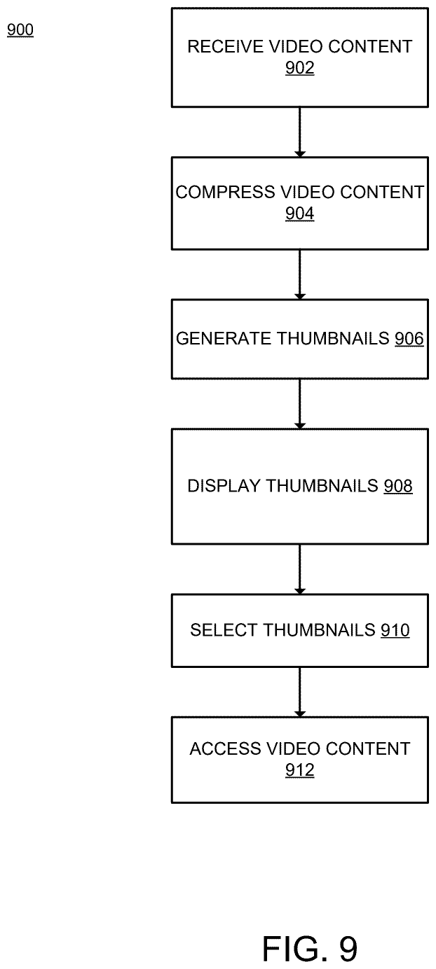

FIG. 9 is a flowchart illustrating a method 900 to manage video content, in accordance with some implementations. Method 900 may begin at block 902.

At block 902, video content is received. The video may or may not include audio. The video may be stored in a variety of video formats, such as MP4, MOV, WMV, AVI, MKV, or WebM or other format. Block 902 may be followed by block 904.

At block 904, the video content is compressed. The compression may include spatial (intra-frame) compression that compresses individual frames as if the frames were still images. The compression may also include temporary (inter-frame) compression that takes advantage of similarities between consecutive frames. Compression may also include color space conversion. The compression may use a variety of codecs to implement the compression. This operation may be optional, in that some video formats compress the video content as part of providing the format. Block 904 may be followed by block 906.

At block 906, thumbnails are generated from the video. For example, a still frame may be sampled from the video at regular intervals when generating thumbnails (for example, each 30 seconds, each minute, each five minutes, etc.). The sampling may differ from random sampling used for content moderation. Alternatively or additionally, a frame may be generated by processing a variety of frames over an interval to generate a representative frame. The thumbnails may be generated from the sampled stills (or sets of stills) using sampling techniques as discussed above.

At block 908, the thumbnails are displayed. For example, the thumbnails may be displayed as a list and/or a matrix. The thumbnails may correspond to different portions of a single video or multiple videos. For example, the thumbnails may correspond to two or more videos but may also correspond to different entry points within the videos. Block 908 may be followed by block 910.

At block 910, a thumbnail is selected by the user. The thumbnail corresponds to a particular video and a point in the video content. For example, the user may select a thumbnail that corresponds to a specific video and also specifies a point in the video content (for example, two minutes after the beginning of the video). Block 910 may be followed by block 912.

At block 912, the selected thumbnail may be used to access the video content. For example, the thumbnail may be associated with a particular video and an entry point into that video. For example, the thumbnail may indicate a particular video, and that playback of the video is to begin at a certain point in the video (for example, two minutes after the beginning of the video. When the video is accessed, the user may play back the video or otherwise manipulate the video. The user may further use the thumbnails to interact with the video playback process.

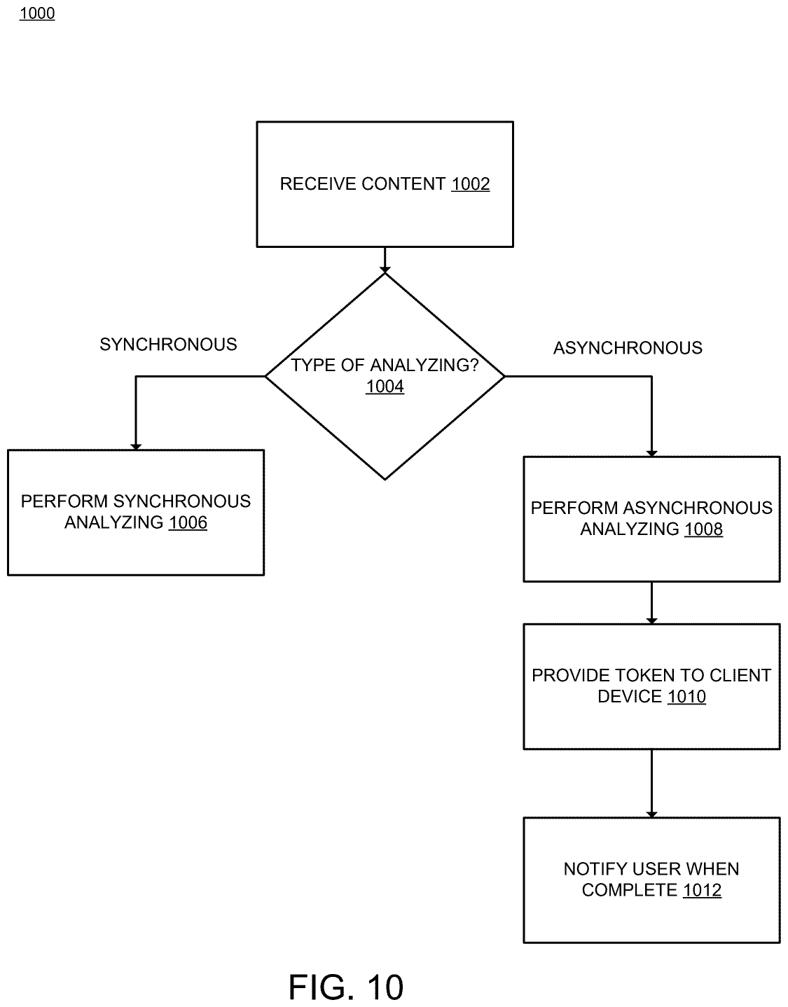

FIG. 10 is a flowchart illustrating a method 1000 to perform various types of analyzing, in accordance with some implementations. Method 1000 may begin at block 1002.

At block 1002, content is received. As discussed herein, the content may include one or more screenshots and/or video (with or without audio) or other content. Block 1002 may be followed by block 1004.

At block 1004, a type of analyzing is selected from between synchronous and asynchronous analyzing. For example, the analyzing may be synchronous if the draft content is one or more screenshots and the analyzing may be asynchronous otherwise (for example, the draft content may be video).

The screenshots may be better adapted for synchronous analyzing because the size of screenshots is more limited than that of video (video may involve increased time to process due to the large amount of information). In some implementations, even if the draft content is screenshots, asynchronous analyzing may still occur. If the analyzing is synchronous, block 1004 is followed by block 1006. If the analyzing is asynchronous, block 1004 is followed by block 1008.

Synchronous analyzing happens in real-time with all participants present simultaneously, demanding immediate responses and facilitating immediate feedback. Asynchronous analyzing occurs over extended periods, permitting participants to work at a selected pace without fixed schedules, which is suitable for tasks involving more consideration. A difference is the presence of a real-time, simultaneous interaction versus a delayed, flexible interaction.

At block 1006, synchronous analyzing is performed. As noted, synchronous analyzing may occur in real time or near real time. Synchronous analyzing may provide a convenient user experience, in that the user does not have to wait for content analysis results. Synchronous analyzing involves computing resources that are able to provide the real time or near real time results, which tend to be greater than those that are used for asynchronous analyzing.

At block 1008, asynchronous analyzing is performed. Because the analyzing is asynchronous, it may not meet specific timing attributes, though the analyzing may still occur in a reasonable amount of time to preserve the integrity of the user experience. Block 1008 may be followed by block 1010.

At block 1010, a token is provided to a client device. The provided token permits the client device to access the draft content in response to storing the draft content once the asynchronous analyzing is complete (whether the draft content was considered safe or unsafe). Block 1010 may be followed by block 1012.

At block 1012, a user is notified when the asynchronous analyzing is complete. The notification lets the user know that the analysis is complete and may also provide the user with information about whether the content is considered safe or unsafe.

FIG. 11 is a flowchart illustrating a method 1100 to validate content, in accordance with some implementations. Method 1100 may begin at block 1102.

At block 1102, hashing is applied to shared content. Various hashing techniques may be applied. The hashing applied to the shared content results in a first hashed value. Block 1102 may be followed by block 1104.

At block 1104, a protected/secure server call is made to the cloud (for example, the call may be made using protected code). This server call permits the cloud to validate the user and sign the capture hash. Block 1104 may be followed block 1106.

At block 1106, a capture hash is signed. As noted, the capture hash may be signed after it is validated that the user is in an appropriate experience. Signing the capture is based on a result of the protected server call and generates a signature. Block 1106 may be followed by block 1108.

At block 1108, a signature is returned. For example, the signature may be returned using a server-side secret key. Block 1108 may be followed by block 1110.

At block 1110, the signature is used for validating. When validating, the signature is stored on the client device and the validating includes passing the signature back to the server on a sharing event, wherein the server hashes the shared content and rebuilds the signature with an experience ID and the server-side secret key to match that the passed signature and the rebuilt signature.

FIG. 12 is a block diagram that illustrates an example computing device 1200 which may be used to implement one or more features described herein, in accordance with some implementations. In one example, computing device 1200 may be used to implement a computer device (e.g., server 102 and/or client device 110 of FIG. 1), and perform appropriate method implementations described herein. Computing device 1200 can be any suitable computer system, server, or other electronic or hardware device. For example, the computing device 1200 can be a mainframe computer, desktop computer, workstation, portable computer, or electronic device (portable device, mobile device, cell phone, smartphone, tablet computer, television, TV set top box, personal digital assistant (PDA), media player, game device, wearable device, etc.). In some implementations, computing device 1200 includes a processor 1202, a memory 1204, input/output (I/O) interfaces 1206, and audio/video input/output devices 1214.

Processor 1202 can be one or more processors and/or processing circuits to execute program code and control basic operations of the computing device 1200. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 1204 is typically provided in computing device 1200 for access by the processor 1202, and may be any suitable processor-readable storage medium, e.g., random access memory (RAM), read-only memory (ROM), electrical erasable read-only memory (EEPROM), flash memory, etc., suitable for storing instructions for execution by the processor, and located separate from processor 1202 and/or integrated therewith. Memory 1204 can store software operating on the computing device 1200 by the processor 1202, including an operating system 1208, a virtual experience application 1210, a content management application 1212, and other applications (not shown). In some implementations, virtual experience application 1210 and/or content management application 1212 can include instructions that enable processor 1202 to perform the functions (or control performance of the functions) described herein (e.g., some or all of the methods described with respect to FIGS. 7-11 or the various workflows and other operations described herein).

For example, virtual experience application 1210 (which can be embodied by the virtual experience application 112 or 132 of FIG. 1) can include a content management application 1212, which as described herein can manage content within an online virtual experience server (e.g., 102). Elements of software in memory 1204 can alternatively be stored on any other suitable storage location or computer-readable medium. In addition, memory 1204 (and/or other connected storage device(s)) can store instructions and data used in the features described herein. Memory 1204 and any other type of storage (magnetic disk, optical disk, magnetic tape, or other tangible media) can be considered “storage” or “storage devices.”

I/O interface(s) 1206 (which can be embodied by the I/O interface 114 of FIG. 1) can provide functions to enable interfacing the computing device 1200 with other systems and devices. For example, network communication devices, storage devices (e.g., memory and/or data store 120), and input/output devices can communicate via I/O interface(s) 1206. In some implementations, the I/O interface(s) 1206 can connect to interface devices including input devices (keyboard, pointing device, touchscreen, microphone, camera, scanner, etc.) and/or output devices (display device, speaker devices, printer, motor, etc.).

The audio/video input/output devices 1214 can include a user input device (e.g., a mouse, etc.) that can be used to receive user input, a display device (e.g., screen, monitor, etc.) and/or a combined input and display device, that can be used to provide graphical and/or visual output.

For ease of illustration, FIG. 12 shows one block for each of processor 1202, memory 1204, I/O interface(s) 1206, and software blocks of operating system 1208, virtual experience application 1210, and content management application 1212. These blocks may represent one or more processors or processing circuitries, operating systems, memories, I/O interfaces, applications, and/or software engines. In other implementations, computing device 1200 may not have all of the components shown and/or may have other elements including other types of elements instead of, or in addition to, those shown herein. While the online virtual experience server 102 is one example of the computing device 1200 that is described as performing operations as described in some implementations herein, any suitable component or combination of components of online virtual experience server 102 or similar system, or any suitable processor or processors associated with such a system, may perform the operations described.

A user device can also implement and/or be used with features described herein. Example user devices can be computer devices including some similar components as the computing device 1200 (e.g., processor(s) 1202, memory 1204, and I/O interface(s) 1206). An operating system, software and applications suitable for the client device can be provided in memory and used by the processor. The I/O interface for a client device can be connected to network communication devices, as well as to input and output devices (e.g., a microphone for capturing sound, a camera for capturing images or video, a mouse for capturing user input, a gesture device for recognizing a user gesture, a touchscreen to detect user input, audio speaker devices for outputting sound, a display device for outputting images or video, or other output devices). A display device within the audio/video input/output devices 1214, for example, can be connected to (or included in) the computing device 1200 to display images pre- and post-processing as described herein, where such display device can include any suitable display device (e.g., an LCD, LED, or plasma display screen, CRT, television, monitor, touchscreen, 3-D display screen, projector, or other visual display device). Some implementations can provide an audio output device, e.g., voice output or synthesis that speaks text.

One or more methods described herein (e.g., methods 700, 800, 900, 1000, and 1100, or the various workflows or other operations) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., field-programmable gate array (FPGA), complex programmable logic device), general purpose processors, graphics processors, application specific integrated circuits (ASICs), and the like. One or more methods can be performed as part of or component of an application running on the system, or as an application or software running in conjunction with other applications and operating systems.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

The functional blocks, operations, features, methods, devices, and systems described in the present disclosure may be integrated or divided into different combinations of systems, devices, and functional blocks. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method to manage content at a server in a virtual environment, the method comprising:
receiving a sharing request from a user via a client device to post shared content to the server;
validating that an origin of the shared content is a valid origin; and
in response to validating that the origin of the shared content is the valid origin:
storing the shared content at the server as draft content;
analyzing the draft content by running a trained server-side artificial intelligence (AI) model to obtain a content moderation result, wherein the content moderation result indicates whether the draft content is safe or unsafe;
in response to the content moderation result indicating that the draft content is safe, decorating and storing the content at the server in a published state, wherein decorating the content comprises customizing and enhancing a visual appearance of the content based on input from the user; and
in response to the content moderation result indicating that the draft content is unsafe, storing the content at the server in a rejected state.

2. The computer-implemented method of claim 1, wherein the shared content comprises video content, one or more screenshots, audio content, or a combination thereof.

3. The computer-implemented method of claim 2, wherein the shared content comprises the one or more screenshots, and wherein the method further comprises:
generating respective thumbnails for the one or more screenshots;
storing the thumbnails; and
compressing the one or more screenshots prior to storing the one or more screenshots.

4. The computer-implemented method of claim 2, wherein the shared content comprises the video content, and wherein the video content is converted into the one or more screenshots by sampling stills from the video content.

5. The computer-implemented method of claim 2, wherein the shared content comprises the video content, and wherein the method further comprises compressing the video content by downsampling the video content to a lower resolution, lowering a frame rate associated with the video content, or a combination thereof, and generating thumbnails associated with the video content for display in a user interface, wherein selection of a thumbnail from the user interface enables access to the video content.

6. The computer-implemented method of claim 1, wherein analyzing the draft content is performed using synchronous analyzing when the draft content is one or more screenshots and is performed using asynchronous analyzing otherwise.

7. The computer-implemented method of claim 6, wherein asynchronous analyzing comprises providing a token to the client device for use in accessing the draft content, in response to storing the draft content and notifying the user when the analyzing is complete.

8. The computer-implemented method of claim 1, further comprising in response to the content moderation result indicating that the draft content is unsafe, performing an appeals process for the draft content, wherein the appeals process is triggered in response to a user request, and wherein the appeals process comprises obtaining a new content moderation result based on different parameters and blocking the draft content again if the new content moderation result is another unsafe result.

9. The computer-implemented method of claim 1, wherein the content moderation result comprises a safety score associated with the draft content, and wherein the method further comprises tagging for human moderation of the draft content that has a safety score lower than a threshold value.

10. The computer-implemented method of claim 1, further comprising in response to validating that the origin of the shared content is the valid origin, displaying the shared content as part of a user profile of an originating user that provided the shared content, wherein the user profile is based on an age of the originating user, a location of the originating user, or a combination thereof.

11. The computer-implemented method of claim 1, wherein validating that the origin of the shared content is the valid origin comprises:
applying a hashing technique to the shared content to obtain a first hash value;
making a server call based on the first hash value using protected code;
signing a capture hash based on a result of the server call to generate a signature;
returning the signature using a server-side secret key; and
using the signature as part of the validating, wherein the signature is stored on the client device and the validating comprises passing the signature back to the server on a sharing event, wherein the server hashes the shared content and rebuilds the signature with an experience ID and the server-side secret key to match the passed signature and the rebuilt signature.

12. A non-transitory computer-readable medium with instructions stored thereon that, responsive to execution by a processing device, cause the processing device to perform or control performance of operations to manage content at a server in a virtual environment, the operations comprising:
receiving a sharing request from a user via a client device to post shared content to the server;
validating that an origin of the shared content is a valid origin; and
in response to validating that the origin of the shared content is the valid origin:
storing the shared content at the server as draft content;
analyzing the draft content by running a trained server-side artificial intelligence (AI) model to obtain a content moderation result, wherein the content moderation result indicates whether the draft content is safe or unsafe;
in response to the content moderation result indicating that the draft content is safe, decorating and storing the content at the server in a published state, wherein decorating the content comprises customizing and enhancing a visual appearance of the content based on input from the user; and
in response to the content moderation result indicating that the draft content is unsafe, storing the content at the server in a rejected state.

13. The non-transitory computer-readable medium of claim 12, wherein analyzing the draft content is performed using synchronous analyzing when the draft content is one or more screenshots and is performed using asynchronous analyzing otherwise.

14. The non-transitory computer-readable medium of claim 13, wherein asynchronous analyzing comprises providing a token to the client device for use in accessing the draft content, in response to storing the draft content and notifying the user when the analyzing is complete.

15. The non-transitory computer-readable medium of claim 12, wherein the content moderation result comprises a safety score associated with the draft content, and wherein the operations further comprise tagging for human moderation of the draft content that has a safety score lower than a threshold value.

16. The non-transitory computer-readable medium of claim 12, wherein the operations further comprise in response to validating that the origin of the shared content is the valid origin, displaying the shared content as part of a user profile of an originating user that provided the shared content, wherein the user profile is based on an age of the originating user, a location of the originating user, or a combination thereof.

17. A system comprising:
a memory with instructions stored thereon; and
a processing device, coupled to the memory, the processing device configured to access the memory and execute the instructions, wherein the instructions cause the processing device to perform or control performance of operations to manage content at a server in a virtual environment, the operations comprising:
receiving a sharing request from a user via a client device to post shared content to the server;
validating that an origin of the shared content is a valid origin; and
in response to validating that the origin of the shared content is the valid origin:
storing the shared content at the server as draft content;
analyzing the draft content by running a trained server-side artificial intelligence (AI) model to obtain a content moderation result, wherein the content moderation result indicates whether the draft content is safe or unsafe;
in response to the content moderation result indicating that the draft content is safe, decorating and storing the content at the server in a published state, wherein decorating the content comprises customizing and enhancing a visual appearance of the content based on input from the user; and
in response to the content moderation result indicating that the draft content is unsafe, storing the content at the server in a rejected state.

18. The system of claim 17, wherein analyzing the draft content is performed using synchronous analyzing when the draft content is one or more screenshots and is performed using asynchronous analyzing otherwise.

19. The system of claim 17, wherein the content moderation result comprises a safety score associated with the draft content, and wherein the operations further comprise tagging for human moderation of the draft content that has a safety score lower than a threshold value.

20. The system of claim 17, wherein the operations further comprise in response to validating that the origin of the shared content is the valid origin, displaying the shared content as part of a user profile of an originating user that provided the shared content, wherein the user profile is based on an age of the originating user, a location of the originating user, or a combination thereof.
